(19) United States
(12) Patent Application Publication
(10) Pub. No.: US 2025/0130178 A1
(43) Pub. Date: Apr. 24, 2025

(54) Surface Inspection Sensor

(71) Applicant: Araz Yacoubian, Encinitas, CA (US)

(72) Inventor: Araz Yacoubian, Encinitas, CA (US)

(21) Appl. No.: 19/001,225

(22) Filed: Dec. 24, 2024

Related U.S. Application Data
(63) Continuation-in-part of application No. 17/881,780, filed on Aug. 5, 2022.
Application No. 17/881,780 is a continuation-in-part of application No. 17/557,124, filed on Dec. 21, 2021, now Pat. No. 11,408,832.
(60) Provisional application No. 63/133,403, filed on Jan. 3, 2021.

(51) Int. Cl. G01N 21/88; G01B 11/02

(52) U.S. Cl. CPC G01N 21/8851; G01B 11/022; G01N 21/8806; G01N 2021/8829; G01N 2021/8845; G01N 2021/8848; G01N 2021/8864; G01N 2021/8874; G01N 2021/8887

(57) ABSTRACT

Various surface and structural defects are currently inspected visually. This method is labor intensive, requiring large maintenance man hours, and is prone to errors. To streamline this process, herein is described an automated inspection system and apparatus based on several optical technologies that drastically reduces inspection time, provides accurate detection of defects, and provides a digital map of the location of defects. The technology uses a sensor that includes a plurality of light sources for emitting light on the structural surface, and a camera for detecting a shadow or an image shift of the structural surface feature. Furthermore, the technology utilizes an image processing and correction apparatus for performing a pattern image and structural surface defect map detection and generate a distortion corrected defect map for a surface scan area on the structure that is incident on the sensor.

### CROSS-REFERENCE TO RELATED APPLICATIONS

This application is a continuation-in-part of U.S. patent application Ser. No. 17/881,780, filed on Aug. 5, 2022, which is a continuation-in-part of U.S. patent application Ser. No. 17/557,124, filed on Dec. 21, 2021, which is a continuation-in-part of U.S. Patent Application 63/133,403 filed on Jan. 3, 2021, the disclosures of which are hereby incorporated by reference in their entireties to provide continuity of disclosures to the extent such disclosures are not inconsistent with the disclosure herein.

### BACKGROUND

Various surface and structural defects are currently inspected visually. This method is labor intensive, requiring large maintenance man hours, and is prone to errors. To streamline this process, herein is described an automated inspection system and apparatus based on several optical technologies that drastically reduces inspection time, provides accurate detection of defects, and provides a digital map of the location of defects.

### SUMMARY

This present invention describes technology uses of multiple sensing/imaging modalities using: i) ring illumination angular scanning, ii) coherent speckle scanning, iii) multi-spectral imaging such as ultraviolet (UV), visible and infrared (IR) spectrums, and iv) using polarization detection. An overview of the approach is shown in FIGS. 1A and 1B. Furthermore, position registration is achieved by wireless (WiFi) triangulation, optical and ultrasonic distance measurements. The final outputs are combined to produce a surface, coating, and structure digital defects map on a 3D structure model. An overview of the approach and the sensor is depicted in FIGS. 1A and 1B. Each of these modalities detects different types and size of defects, as described herein. For example, ring illumination angular scanning (i) reveals defects were either part of, or the entire coating is removed, because reflectivity will have a different angular directionality. Comparing images with illumination incident at multiple angles increases defect detection accuracy drastically. In addition, an optimal signal is obtained at a given angle, and using multi-angle scanning enables defect detection without the need of high-precision angular alignment. Thus, a sensor based on the present invention can be used for hand-held inspection. The coherent speckle scanning (ii) measures micro-pits, voids, small/pinhole defects, cracks, and discontinuities on the surface of a coating and structure. Multi-spectral (UV, visible and IR) imaging (iii) is used for multi-material assessment to distinguish between defects at different material layers, and (iv) differential polarization detection reveals defects by detecting a variation in the surface finish such as the coating and the structure body. The data captured by the sensor is transferred to a handheld, portable display that includes the 3D model of the structure and shows both the completed scan areas and detected defects.

### BRIEF DESCRIPTION OF THE DRAWINGS

Embodiments of the invention relating to both structure and method of operation may best be understood by referring to the following description and accompanying drawings.

FIG. 1A is perspective pictorial and block diagrams illustrating an embodiment for automated inspection of structure.

FIG. 1B is perspective pictorial and block diagrams illustrating an embodiment for a sensor head for surface inspection.

FIG. 1C is perspective pictorial and block diagrams illustrating an embodiment for a sensor head in an array configuration for surface inspection.

FIG. 1D is perspective pictorial and block diagrams illustrating an embodiment for a sensor head and positioning markings for surface inspection.

FIG. 1E is perspective pictorial and block diagrams illustrating an embodiment for a sensor head for surface inspection along various points on the structure.

FIGS. 2A-2C are perspective pictorial and block diagrams illustrating an embodiment that describes angular scanning illumination.

FIG. 3 is a perspective pictorial and block diagram illustrating an embodiment for polarization imaging.

FIGS. 4A-4F are perspective pictorial and block diagrams illustrating various multi-state polarization detection methods and apparatus.

FIGS. 5A-5D are perspective pictorial and block diagrams illustrating various embodiments for generating speckle illumination.

FIG. 6 is a perspective pictorial and block diagram illustrating an embodiment for multi-wavelength imaging.

FIG. 7 is a perspective pictorial and block diagram illustrating a multi-wavelength polarization imaging.

FIGS. 8A and 8B are pictorial diagrams illustrating angular illumination scanning defect detection.

FIGS. 9A and 9B are pictorial diagrams illustrating differential polarization defect detection.

FIGS. 10A-10C are pictorial diagrams illustrating coherent speckle scanning defect detection.

FIGS. 11A and 11B are pictorial diagrams showing images and data that illustrate image improvement by using speckle noise reduction techniques.

FIG. 12 depicts a sensor for inspecting surfaces.

FIGS. 13A-13D depict various sensor head or inspection head configurations.

FIG. 14 depicts a generalized configuration of attaching additional optics to the sensor unit.

FIGS. 15A-15H depict various example configurations of attaching additional optics to the sensor unit.

FIG. 16 is a pictorial block diagram illustrating a schematic of inspection unit for detecting defects using inspection apparatus.

FIG. 17 is perspective pictorial and block diagrams illustrating an embodiment for a sensor head that incorporates a projection pattern for surface inspection.

FIG. 18 is perspective pictorial and block diagrams illustrating an embodiment of a projection pattern generator for surface inspection.

FIG. 19 depicts various projection patterns.

FIG. 20A is a pictorial block diagram illustrating a projected pattern onto a flat surface.

FIG. 20B is a pictorial block diagram illustrating a projected pattern onto a curved surface.

FIG. 20C is a pictorial block diagram illustrating a projected pattern onto a flat surface at an angled incidence.

FIG. 20D is a pictorial block diagram illustrating a projected pattern onto a curved surface at an angled incidence.

FIG. 21 is a pictorial block diagram illustrating a schematic of an inspection unit for detecting defects combined with a projected pattern for image distortion correction.

FIG. 22 is a pictorial block diagram illustrating a schematic of an inspection unit for detecting defects using an inspection apparatus combined with a projected pattern for image distortion correction, combined with a position determination to produce a defect map of the entire inspected object surface.

FIG. 23 is a perspective pictorial block diagram illustrating a sensor head with a single camera and a plurality of multi-wavelength light sources inspecting a structure or object.

FIG. 24 is a perspective pictorial block diagram illustrating a sensor head with a single camera and a plurality of multi-wavelength light sources oriented in horizontal and vertical directions inspecting a structure or object.

FIGS. 25A-25C depict various sensor head or inspection head configurations for inspecting surfaces with protrusions and indentations.

FIG. 26 is a perspective pictorial block diagram illustrating steps for detecting height and depth of a feature or defect.

FIG. 27 is a perspective pictorial block diagram illustrating processing steps to indicate light source position by extracting illumination wavelength from detected image, and to indicate illumination angle of incidence.

FIG. 28A depicts a linear feature and a circular or elliptical defect.

FIG. 28B depicts a wide feature and a thin feature such as a crack.

FIG. 29A depicts a linear feature that undergoes a spatial frequency transformation to produce a linear pattern.

FIG. 29B depicts a circular or elliptical feature that undergoes a spatial frequency transformation to produce a circular or elliptical pattern.

FIG. 30 is a perspective pictorial block diagram illustrating a sensor head with multiple cameras and a plurality of multi-wavelength light sources inspecting a structure or object.

FIG. 31 is a perspective pictorial block diagram illustrating a sensor head with multiple cameras and a plurality of multi-wavelength light sources oriented in horizontal and vertical directions inspecting a structure or object.

FIG. 32A depicts apparatus that uses beam splitting optics that direct scattered or reflected light from an object to plurality of directions to produce multiple shifted images onto a camera or a detector array.

FIG. 32B depicts apparatus that uses beam splitting optics that direct scattered or reflected light from an object to plurality of directions to produce shifted images onto two or more cameras or a detector arrays.

FIG. 32C depicts an apparatus that uses beam splitting optics that direct scattered or reflected light from an object to plurality of directions, such as in orthogonal directions, to produce shifted images onto two or more cameras or detector arrays.

FIG. 33A depicts an apparatus that uses multiple beam splitters or splitting optics that direct scattered or reflected light from an object to a plurality of directions to produce multiple shifted images onto a camera or a detector array.

FIG. 33B depicts an apparatus that uses multiple beam splitters or splitting optics that direct scattered or reflected light from an object to a plurality of directions to produce shifted images onto two or more cameras or a detector arrays.

FIGS. 34A and 34B depict various examples of pattern projection to detect indentation and protrusion.

### DETAILED DESCRIPTION

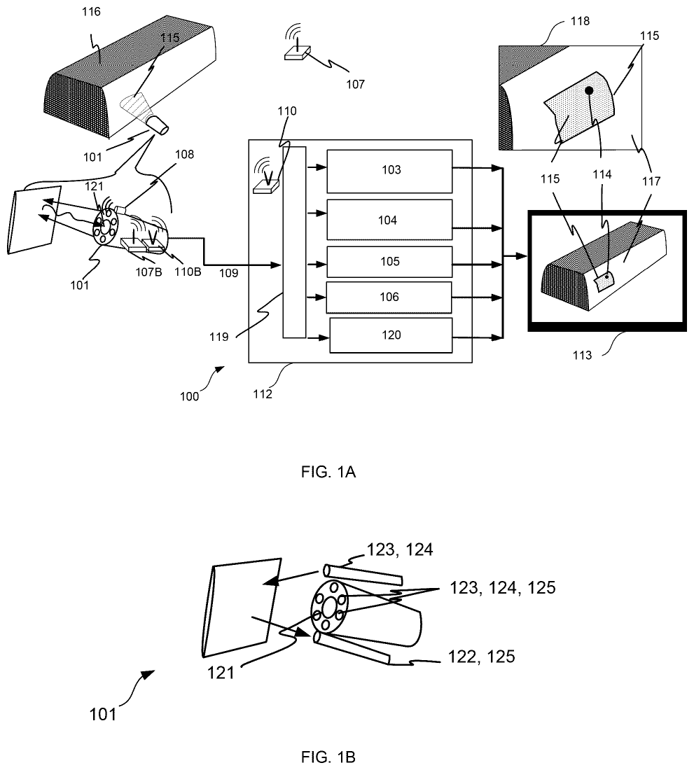

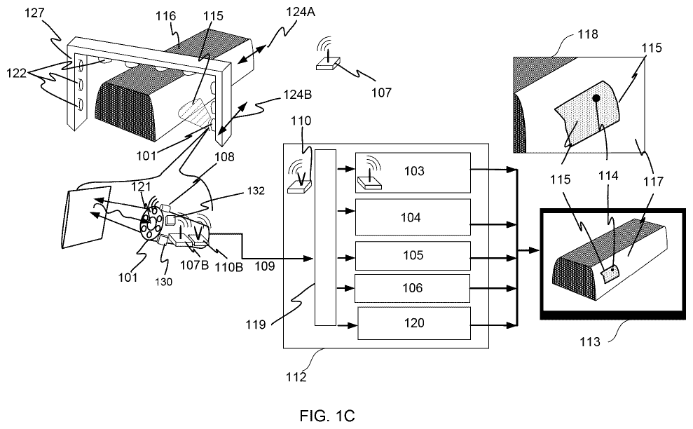

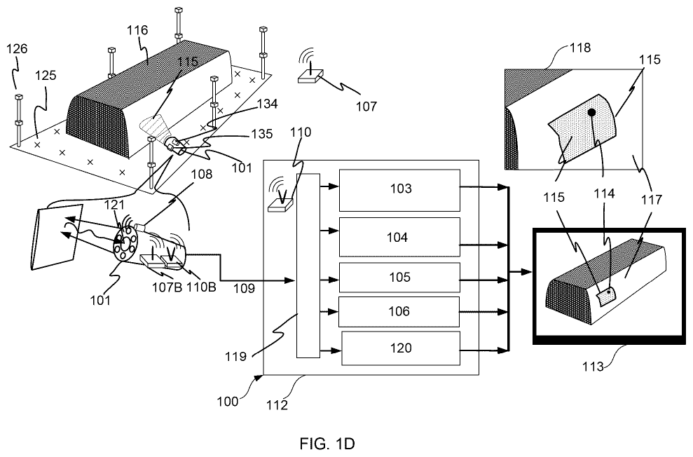

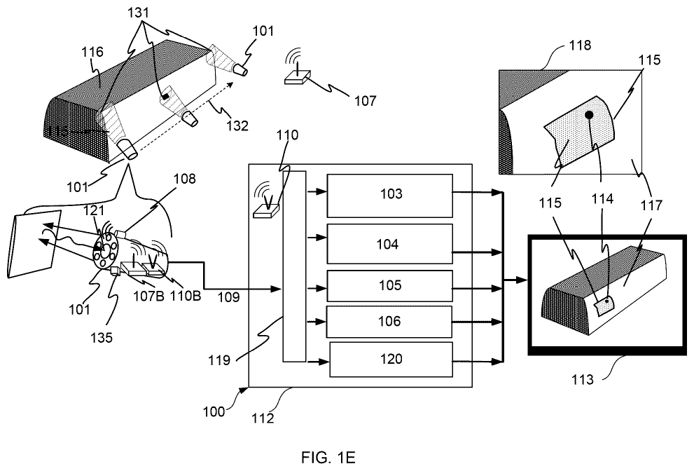

FIGS. 1A, 1B, 1C, 1D and 1E illustrate an overview of an automated inspection sensor unit and methodology. FIG. 1A is a pictorial block diagram illustrating a schematic of an automated inspection sensor unit and methodology 100 used for inspecting a relatively large structure of arbitrary shape 116 or a specimen. FIG. 1B is perspective pictorial and block diagram illustrating an embodiment depicting details of the sensor head 101, which is a handheld or portable/movable unit. FIG. 1A apparatus uses multiple parameters for inspection which include i) scanning radial or ring illumination 103 by sequentially pulsing each light source and detecting each angle which generates angular scan data, ii) coherent speckle illumination 104 generated by a combination of laser diodes, and scattering media, to detect very small defects, and iv) multi-wavelength imaging 105, where a combination of multi-wavelength LEDs are used for identifying defects in a structure, surface coating, and underlying material, and iii) polarization imaging 106 using polarization components that are mounted in front of the cameras, or using multiple adjacent cameras with polarizers oriented orthogonal to each other or at a different polarization angle from each other. Sensor unit position is obtained using wireless position receivers and transceivers (WiFi) 107. Further accuracy is achieved using ultrasonic range distance measurement finder 108 also attached to the sensor head to measure distance between sensor head and structure or specimen body, or an optical device, such as a light emitting diode or laser-based range finder, or a combination thereof. Data is transferred via wired 109 or wireless 110 transmission to a processor 112. Two wireless transceivers may be used, one transceiver 110B placed on the sensor head 101 and another transceiver 110 placed in the processor 112. The wireless transceivers used for positioning 107 are connected wirelessly to a wireless transceiver 107B placed on the sensor head, which moves with the sensor. One or more wireless transceivers 107 may be placed around the structure or object being tested. Digital display (either hand-held/portable or attached to the sensor unit) displays the section of the completed scan on a 3D structure model 113. The display also shows the location of defects 114, the completed scan area 115 displayed on the structure 116, and model 117, as depicted in FIG. 1A, and the details shown in the inset 118. The processor 112 is composed of pre-processor 119 to take raw sensor data, and combine the multiple inspection modalities 103, 104, 105, 106, and the position registration data 120 generated from positioning receivers and transceivers 107 and ultrasonic range distance measurement finder 108 apparatus. The sensor head 101 contains one or more cameras or image capturing apparatus 121, either centrally located, or off-centered 122 as indicated in FIG. 1B. Sensor head 101 contains coherent and incoherent optical sources (light sources) and optical components such as lenses, spectral filters and polarization controlling components 123 and 125, as well as single and multi-element optical detectors 124.

FIG. 1C is perspective pictorial and block diagrams illustrating an embodiment for a sensor head 101 in an array configuration for surface inspection utilizing a plurality of the sensors 101 in a sensor array configuration 122, attached to an array holder 127 or an apparatus that holds a plurality of sensors 101. This apparatus 123 is used to rapidly scan the entire structure 116. The rapid scanning is achieved either by a) setting the array holder 123 stationary and moving the structure 116 as depicted in the object movement 124A, or b) setting the structure 116 stationary and moving the array holder 127 in the sensor array movement direction 124B, or a combination thereof.

In some embodiments, the sensor head 101 contains various positioning registration sensors 130, such as an accelerometer-based sensor, an inertial mass sensor, a magnetometer, or a combination thereof to determine the viewing direction of the sensor head 101, determine a movement of the sensor head 101 with respect to the structure 116, determine an acceleration of the sensor head 101, determine a velocity of the sensor head 101, determine a movement distance of the sensor head 101, and determine a direction of movement of the sensor head 101, or a combination thereof. It should be obvious to those skilled in the art that velocity of the sensor head 101 is determined by integrating accelerometer data, and the movement distance of the sensor head 101 is determined by integrating velocity data. In other embodiments, sensor head 101 incorporates a device 132 that indicates direction, tilt and movement of the sensor head 101 by using an accelerometer, a gyroscope such as a fiber-optic gyroscope or a micro-electro-mechanical gyroscope, a magnetometer, or a combination thereof, including one or more of such devices.

A unique aspect of the present invention is that the embodiment for a sensor head 101 in FIG. 1C may optionally include wireless position receivers and transceivers (WiFi) 107 and 107B in order to more accurately obtain a position of the sensor head 101, as discussed above. In this manner, the wireless position receivers and transceivers (WiFi) 107 and the sensor array configuration 122, along with the array holder 127 can be used to more accurately obtain a position of the sensor head 101. However, it is to be understood that the sensor array configuration 122, along with the array holder 127 can be used on their own to accurately obtain a position of the sensor head 101.

FIG. 1D is perspective pictorial and block diagrams illustrating an embodiment for a sensor head 101 utilizing stationary ground makers 125 and height markers 126 for determining the position of the sensor head 101 with respect to the structure 116. Utilizing the ground markers 125 and height markers 126, the sensor head 101 can be pointed to these markers and the position data recorded to reference the sensor head 101 position with respect to the structure 116.

In some embodiments similar to FIG. 1D, the data obtained by pointing the sensor head 101 to the ground markers 125 and height markers 126 is combined with the distance measurements sensor such as ultrasonic range distance measurement finder 108, an optical or lased distance measurement sensor placed on the sensor head 101, an accelerometer based sensor attached to the sensor head 101, an inertial mass sensor or a magnetometer attached to the sensor head 101, a wireless positioning based sensor 107 and 107B attached to sensor head 101, or any combination thereof, to achieve an accurate determination of the sensor head 101 position with respect to the structure 116.

Another unique aspect of the present invention is that the embodiment for a sensor head 101 in FIG. 1D may optionally include wireless position receivers and transceivers (WiFi) 107 and 107B in order to more accurately obtain a position of the sensor head 101, as discussed above. In this manner, the wireless position receivers and transceivers (WiFi) 107 and 107B and the ground markers 125 and height markers 126 combined with the distance measurements sensor such as ultrasonic range distance measurement finder 108 can be used to more accurately obtain a position of the sensor head 101 with respect to structure 116. However, it is to be understood that the ground markers 125 and height markers 126 combined with the distance measurements sensor such as ultrasonic range distance measurement finder 108 can be used on their own to accurately obtain a position of the sensor head 101 with respect to structure 116.

In some embodiments similar to FIG. 1D, the sensor head 101 contains a laser source 134 or a light source that produces a small point, a cross, a circular mark, or an arbitrary light shape to enable accurate pointing and centering of the sensor head 101 towards the ground markers 125 and height markers 126.

In other embodiments similar to FIG. 1D, the sensor head 101 contains additional optical sensors or imaging sensors directed at multiple orientations that record the position of sensor head 101 by utilizing the ground markers 125 and height markers 126 without the need to point the sensor head to each marker.

In some embodiments similar to FIG. 1D, one or more cameras 135 are attached to the sensor head 101 to detect the position of the sensor head with respect to the ground markers 125 and height markers 126 using image registration.

FIG. 1E is perspective pictorial and block diagrams illustrating an embodiment for a sensor head 101 for surface inspection by referencing along various points on the structure 116 such as edges, corners, surface features 131 and surface markings for determining the inspection position of sensor head 101 with respect to the structure 116. By utilizing various points on the structure 116 such as edges, corners, surface features and markers 131, the sensor head 101 can be pointed to reference points and record the position data to reference the sensor head 101 position with respect to the structure 116.

In some embodiments similar to FIG. 1E, the data obtained by pointing the sensor head 101 to various points on the structure 131 is combined with a distance measurements sensor such as ultrasonic range distance measurement finder 108, an optical or lased distance measurement sensor placed on the sensor head 101, an accelerometer based sensor attached to the sensor head 101, an inertial mass sensor or a magnetometer attached to the sensor head 101, a wireless positioning based sensor 107 and 107B attached to sensor head 101, or any combination thereof, to achieve an accurate determination of the position of the sensor head 101 with respect to the structure 116.

Another unique aspect of the present invention is that the embodiment for a sensor head 101 in FIG. 1E may optionally include wireless position receivers and transceivers (WiFi) 107 and 107B in order to more accurately obtain a position of the sensor head 101, as discussed above. In this manner, the wireless position receivers and transceivers (WiFi) 107 and 107B and the distance measurements sensor such as ultrasonic range distance measurement finder 108, the optical or lased distance measurement sensor placed on the sensor head 101, the accelerometer-based sensor attached to the sensor head 101, the inertial mass sensor or a magnetometer attached to the sensor head 101 can be used to more accurately obtain a position of the sensor head 101 with respect to structure 116. However, it is to be understood that the distance measurements sensor such as ultrasonic range distance measurement finder 108, the optical or lased distance measurement sensor placed on the sensor head 101, the accelerometer based sensor attached to the sensor head 101, the inertial mass sensor or a magnetometer attached to the sensor head 101 and the ground markers 125 and height markers 126 combined with the distance measurements sensor such as ultrasonic range distance measurement finder 108 can be used on their own to accurately obtain a position of the sensor head 101 with respect to structure 116.

In some embodiments similar to FIG. 1E, a camera 135 is attached to the sensor head 101 to detect the position of the sensor head 101 with respect various points on the structure 116 such as edges, corners, surface features and markers 131 using image registration.

In some embodiments similar to FIGS. 1C and 1D, the camera used for generating the defect map, as described herein are used for detecting position of the sensor head 101 with respect to the ground markers 125 and height markers 126.

In some embodiments similar to FIGS. 1A and 1B, position detection devices are used for transferring captured data to structure coordinates. In other embodiments, ultrasonic range finders 108 are used for position measurements.

In some embodiments similar to FIGS. 1A and 1B, position detection devices are comprised of wireless, ultrasonic, or optical transceivers, or a combination thereof.

In some embodiments similar to FIGS. 1A and 1B, when multiple position detection devices, such as multiple wireless transceivers 107 are used, the data from theses transceivers is a triangulation method is utilized to determine the position of the sensor head 101.

In some embodiments similar to FIGS. 1A and 1B, the multiple position transceivers 107 may be connected wirelessly, wired, or a combination thereof.

In some embodiments similar to FIG. 1C, the array holder 127 movement is measured using a sensor such as an encoder, a laser distance measurement sensor, a rolling element encoder, or any number of contact or non-contact encoder elements.

In some embodiments similar to FIG. 1C, the movement of the structure 116 is measured by placing it on a roller or conveyer belt to move 124A.

In some embodiments similar to FIG. 1C, the movement of the structure 116 is measured using an accelerometer, an optical or a laser distance measurement sensor or a linear encoder attached on the structure 116. In another embodiment similar to FIG. 1C, the movement of the structure 116 is measured using an optical or a laser distance measurement sensor that is placed at a fixed position external to the structure and pointed to the structure.

In some embodiments similar to FIG. 1C, positioning registration sensors 130 and device 132 that indicates direction, tilt and movement of the sensor head 101 are combined into a single sensor device.

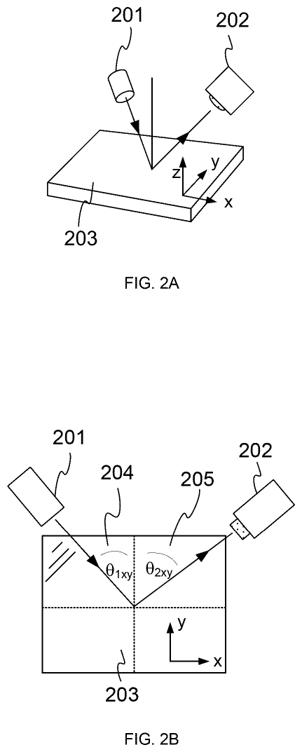

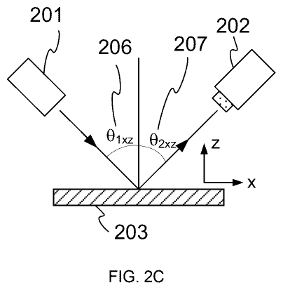

FIGS. 2A to 2C are perspective pictorial and block diagrams illustrating an embodiment that describes angular scanning illumination. FIG. 2A depicts a perspective light source 201 that is positioned at an arbitrary angle of incidence with respect to camera 202, thereby detecting defects at that angle. FIG. 2B is the top view indicating the variation in the angles in radial direction, and FIG. 2C is the side view of the detection, indicating variations in the vertical angular direction 207. FIGS. 2B and 2C depict light source 201, camera 202, specimen 203 or the surface being tested, incident angle in planar x-y directions 204 and reflected or scattered angle in vertical x-y direction 205, reflected or scattered angle in planar x-y direction 202, incident angle in vertical x-z direction 206, and reflected or scattered angle in vertical x-z direction 207. The specimen 203 can be a large structure or a small object.

In some embodiments, the light source 201 and the camera 202 are at fixed positions. In other embodiments, the light source 201 or the camera 202, or both are shifted mechanically. Yet in other embodiments multiple light sources, multiple cameras, or a combination of both are placed at various angular positions, and when the light source 201 is turned on simultaneously or sequentially, the cameras capture is turned on simultaneously or sequentially, or a combination thereof. Yet in other embodiments, the various light source and camera turn on time and capture time are synchronized to produce images and detection data at various detection angles.

Since reflection between multiple layers has different angular characteristics, such as different angles of scattering, and different reflections, defects such as voids, cracks, bulging and gaps, or large gaps in the lines can be detected using angular scanning illumination.

It is to be understood that the terms angular and radial are used interchangeably throughout this application.

In some embodiments, sensor arrangements described throughout this application and depicted in FIGS. 1A and 1B and 2A-2C, angular scan refers to either radial angle, namely in the x-y direction depicted in FIG. 2A, or vertical angle, namely in the x-z direction depicted in FIG. 2A, or a combination of both, namely at any arbitrary angle in the direction. The terms angular and radial are used interchangeably throughout this application.

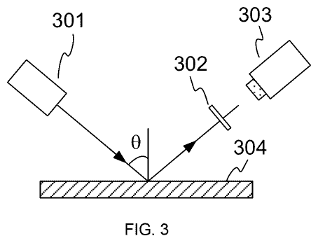

FIG. 3 is a perspective pictorial and block diagram illustrating an embodiment for polarization imaging using a light source 301 illuminating a specimen 304, and a camera 303 with a polarizer 302 placed in front of the camera 303. In alternative embodiments, the light source 301 can be polarized, randomly polarized or circularly polarized. In other embodiments, a polarizer, a wave plate, or a combination of both are used in front of the light source 301 to control the state of the incident light polarization.

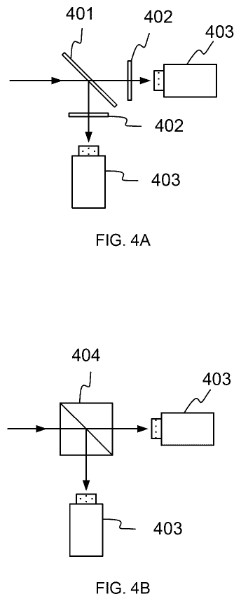

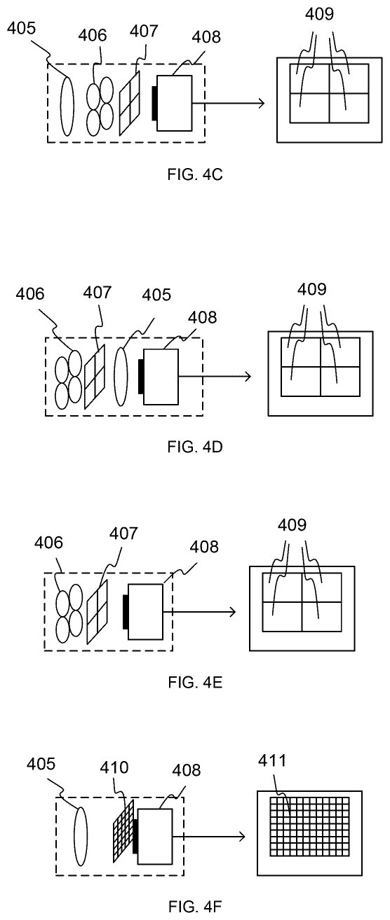

FIGS. 4A to 4F are perspective pictorial and block diagrams illustrating an embodiment depicting various methods of simultaneously detecting multiple polarization states. FIGS. 4A to 4F depict beam splitter 401, polarizer 402, camera 403, polarization 404, imaging lens 405, lens or lenslet array 406, polarizer array 407, focal plane array 408, multiple images each for different polarization state 409, polarizer fine array 410, and each pixel or cluster of pixels represent different polarization state 411.

FIG. 4A depicts using a beam splitter 401, such as a reflective plate beam splitter, a cube beam splitter, or a diffractive beam splitter, combined with polarizers in front of each camera. FIG. 4B depicts using a polarization beam splitter. FIGS. 4C to 4E illustrates use of lens array and polarizer arrays to capture multiple polarization states. FIG. 4F illustrates use of a fine polarizer array in front of the camera 403 or embedded on the camera chip to produce multiple state polarization images. In an alternative embodiment similar to FIGS. 4A and 4B, focusing lenses are placed in front of each camera after the beam splitter. Yet in another embodiment similar to FIGS. 4A and 4B, a focusing lens is placed before the beam splitter resulting in focused images on both cameras. In various embodiments similar to FIGS. 4A to 4F, the images are combined digitally to determine various polarization states, indicate the difference in between states, and shift the images for overlap of the images, or a combination thereof.

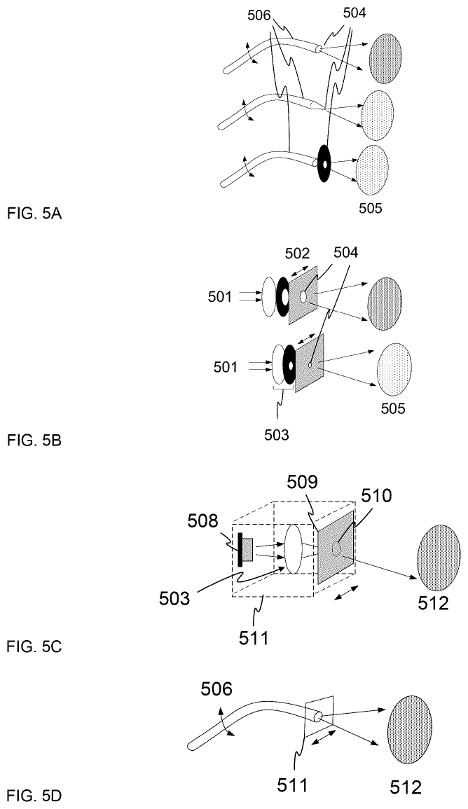

FIGS. 5A to 5D show various methods of generating illumination of different speckle sizes. In FIG. 5A, a diffuse media combined with aperture control generates speckles of a desired size. In FIG. 5B, multi-mode fibers of different diameters (or using fiber tapers) are used to generate speckles of different size.

FIGS. 5A to 5D show two types of apparatus to generate coherent illumination 501 for defect detection. Speckle size 505 is controlled using aperture control and diffuse media (FIG. 5A) and using a multi-mode fiber of different sizes (FIG. 5B). To remove speckle noise from the image, the random media or the multi-mode fiber can be moved during image acquisition. FIGS. 5A and 5B depict a coherent light source 501, a moving diffuser 502, optics and iris 503, and controlled aperture 504. The apparatus controls the speckle size 505 and incorporates a moving fiber 506 that reduces the speckle noise in the detected image.

In the apparatus shown in FIGS. 5A to 5D, several coherent sources are used (such as laser diodes) in conjunction with speckle generation apparatus. Each source generates a particular range of sizes of speckles. The source is combined either with optics and random media as shown in FIG. 5A or coupled to multi-mode fibers of different apertures as shown in FIG. 5B. When using multi-mode optical fibers, either fibers of different diameters are employed, or the aperture is controlled using fiber tapers. An example of fiber tapers is illustrated in FIG. 5A.

FIGS. 5C and 5D show two types of apparatus to generate coherent illumination for small defect detection. Speckles are generated using diffuse media (FIG. 5C) and using a multi-mode fiber (FIG. 5D). To remove speckle noise from the image, the diffuse media or the multi-mode fiber is moved rapidly. To minimize false detection, the speckle generation apparatus is spatially modulated, as described herein. FIGS. 5C and 5D depict optics and iris 503, fast moving fiber 506, laser diode (LD) 508, fast moving diffuser 509, illuminated spot of light on the diffuser 510 by LD, spatially modulated speckle generator 511, and speckle illumination 512.

To remove speckle noise from the image, the random media or the multi-mode fiber is moved during image acquisition.

In some embodiments similar to FIGS. 5A to 5D, the coherent source, is a laser diode, a super luminescent source, a light emitting diode (LED), a light source or an LED with a narrow band wavelength filter placed in front of it or in the optical path, a gas laser, a solid-state laser, or any other coherent or partially coherent source.

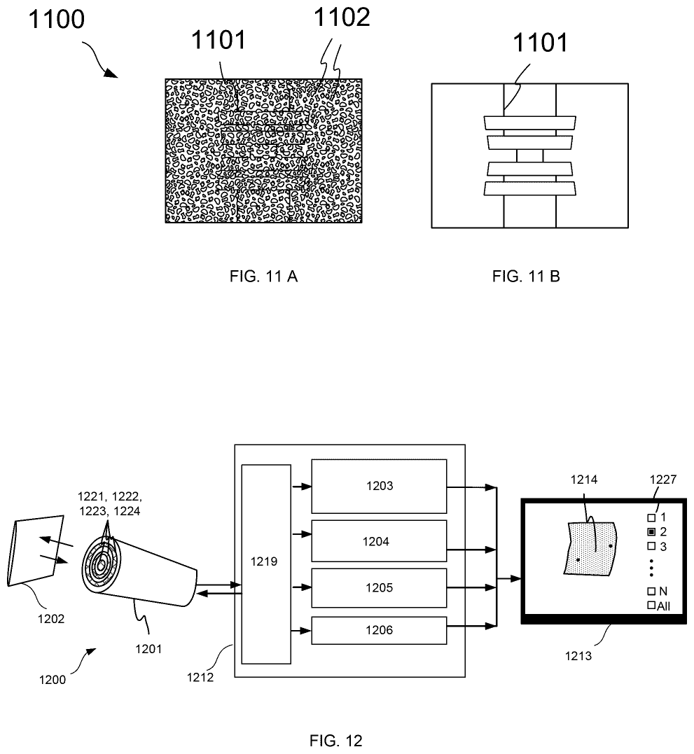

To reduce speckle noise from the image while maintaining the advantage of granularity detection, either the random media, or the multi-mode fiber as shown in FIGS. 5A to 5D are conventionally moved to smooth the detected image. Examples of speckle noise reduction are shown in FIGS. 11A and 11B.

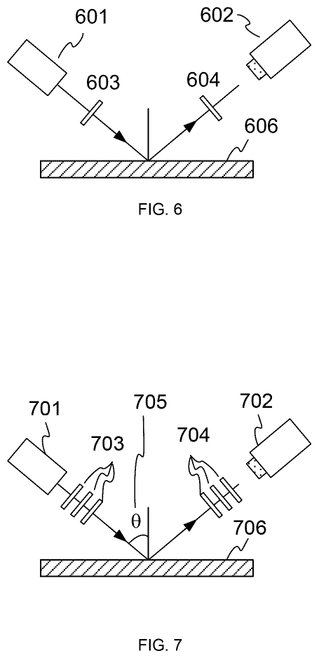

FIG. 6 is a perspective pictorial and block diagram illustrating an embodiment for multi-wavelength imaging using spectral filters placed in front of the light source and in front of the cameras. Multi-wavelength measurements are achieved using multi-color LEDs combined with monochrome cameras, or using white light sources combined with color filters, as depicted in FIG. 6. FIG. 6 depicts light source 601, camera 602, filter 1 603, filter 2 604, and specimen 606.

For the apparatus depicted in various figures in the present invention, it is to be understood that the camera image is digitized, transferred to a computer, and image processing and computing are conventionally performed.

FIG. 7 is a perspective pictorial and block diagram illustrating spectral or multi-wavelength polarization imaging using a combination of polarizers, wave-plates, and spectral filters. In some embodiments, only linear polarizers are used in front of the camera 702. In other embodiments, polarizers are used in front of the light source and in front of the camera. Yet in other embodiments, wave-plates are added to control the polarization state, from linear to elliptical to circular. FIG. 7 depicts light source 701, camera 702, polarizer, wave plate and filter 703 placed in the incident light path, and a polarizer, wave plate and filter 704 placed in the reflected or scattered light path from the specimen 706, at an incident angle θ 705.

In some embodiments similar to FIGS. 6 and 7, a monochromatic light, a laser, a white light, a broad spectral light with a spectral filter in front of it, or a spectral filter are used. In other embodiments a filter in front of the camera, or a color camera, or a combination thereof are used.

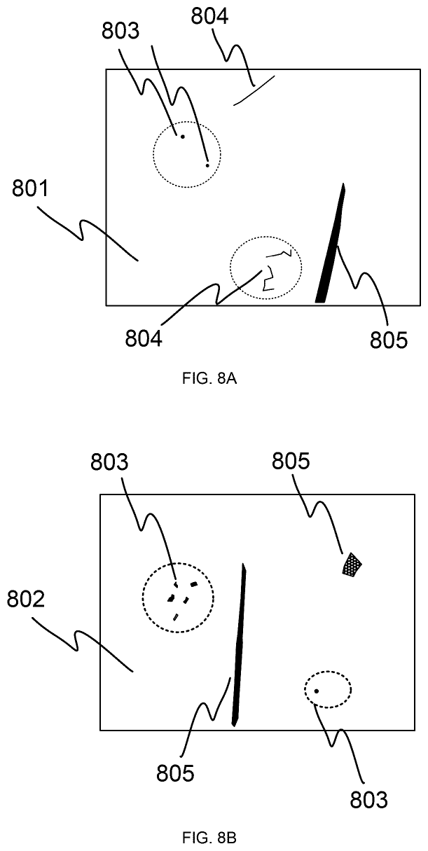

FIGS. 8A and 8B are pictorial diagrams of defect maps that result from angular illumination scanning. This scanning reveals various types of defects on various substrates and coatings such as A) a metal plate coated with a gray paint 801 depicted in FIG. 8A, and on B) a black plastic substrate coated with black paint 802 depicted in FIG. 8B. Detected defects shown in FIGS. 8A and 8B are pinholes 803, a shallow scratch 804 on surface, and a deep scratch 805 down to the plate or substrate.

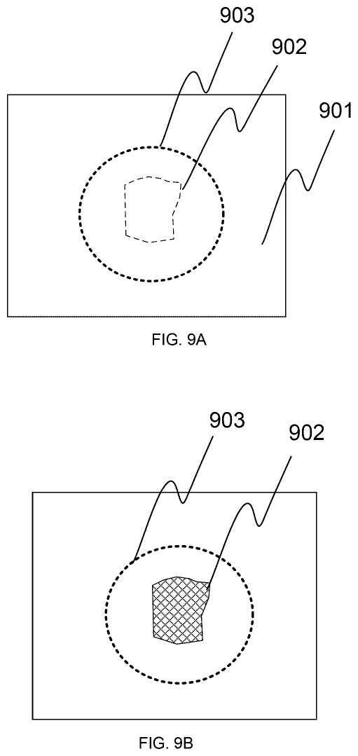

FIGS. 9A and 9B are pictorial diagrams of defect maps illustrating use of differential polarization imaging to reveal a layer of rectangular spot that has a different finish than the surrounding spray coated finish of the surface. The rectangular area mimics a layer of a different finish, such as due to damage to the surface or a defective surface. FIG. 9A shows an image using conventional photography, such as a flash photography, of a flat-gray spray coated substrate 901 with a rectangular section 902 inside the dotted circle 903 that has a polished surface to mimic a layer of a different finish. It is to be understood that the rectangular section 902 is not observable by conventional photography. In contrast, FIG. 9B depicts differential polarization detection, where it reveals a rectangular polished spot 902 inside the dotted circle 903 that has a different surface finish than the surrounding area.

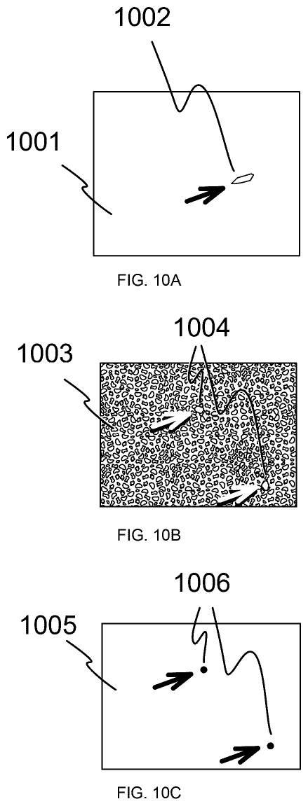

FIG. 10A to 10C are pictorial diagrams illustrating use of coherent speckle scanning imaging with different speckle sizes to reveal defects. FIG. 10A illustrates a microscopic image of a defect 1002 on a surface 1001. FIG. 10B depicts detection of two defects 1004, one of which is shown in FIG. 10A, using coherent speckle scanning method. The defect map shown in FIG. 10B results using coarse speckle size that is large compared to the defect size. Utilizing large speckles compared to the defect size results in a defect map with a background with speckle noise 1003. FIG. 10C depicts coherent speckle scanning imaging with fine speckle size, namely on the order of or smaller than the defect size, which results in a defect signature 1006 with a minimum background noise 1005. Arrows in FIGS. 10A to 10C point to the position of the defects. Image width of FIGS. 10B and 10C are approximately 3 times the image width of FIG. 10A. As illustrated in FIGS. 10A to 10C, being able to control the speckle size as depicted in FIGS. 5A to 5D enable increasing the signal-to-noise ratio of detection.

FIG. 11 shows an example of speckle noise reduction 1100 while imaging a specimen 1101, and speckle noise 1102. When the fiber or diffuser depicted in FIGS. 5A to 5D is stationary, the image produced is very noisy as indicated in FIG. 11A. When the diffuser or multi-mode fiber are moving rapidly, the speckle noise is minimized or removed, and the specimen 1101 or the surface being tested is imaged with clarity, as depicted in FIG. 11B.

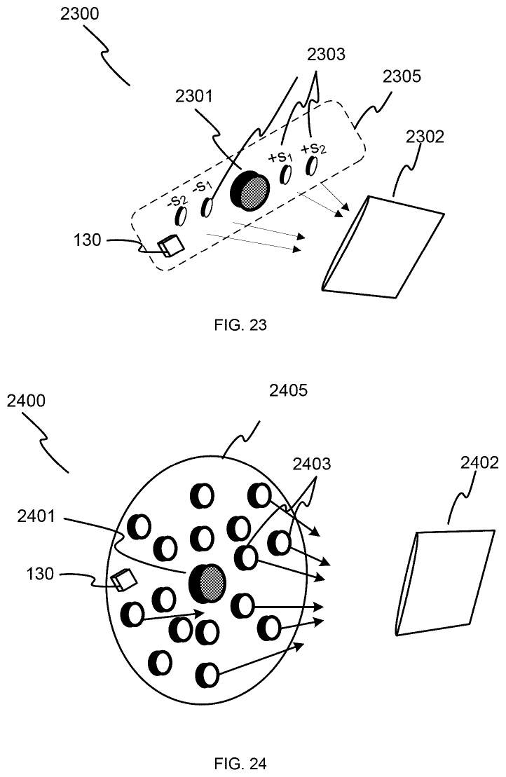

FIG. 23 is a perspective pictorial and block diagram illustrating an embodiment depicting details of an apparatus 2300 having a sensor head 2305 that includes plurality of light sources 2303 of different wavelengths such as light emitting diodes (LED) or a laser diode, a structure, object or a surface 2302 being tested. Reflected or scattered light from the object or a surface 2302 is captured by the image capturing device such as camera 2301. In some embodiments, each of the light sources 2303 is a single wavelength or wavelength band or consists of multiple elements with each element being of different wavelengths, or a combination thereof. The apparatus 2300 can also include a registration sensor 130. The light sources 2303 are sequentially turned on while camera 2301 is capturing the signal, or turned on simultaneously, or a combination thereof. The camera 2301 is either a monochromatic camera and determines which light source 2303 turns on via timing of the light source trigger signal, or a camera that has multiple channels of different wavelength outputs. The fact that each light source 2303 is configured with a different wavelength enables determination of which light source 2303 is on by use of light source timing signal, but also when multiple light sources 2303 of different wavelengths are turned on simultaneously, various output channels of the camera image result from the corresponding illumination of a particular light source 2303. This parallel approach significantly enhances the speed of detection. For example, if three light sources 2303 of three different wavelengths are turned on in parallel, and detected by three channels of the camera 2301, then the capture rate is three times faster than using a single channel approach.

Each light source 2303 of a different position enables illumination of different angles, which enable enhanced detection of defects, and depth and height determination, as described herein. Using this approach enables detection and classification of various types of defects, detection of defects of different layers or features of different color or surface finish, and to determine depth or height of features and defects as described herein. Furthermore, the apparatus shown in FIG. 23 is attached to various embodiments described herein to produce a large area scan.

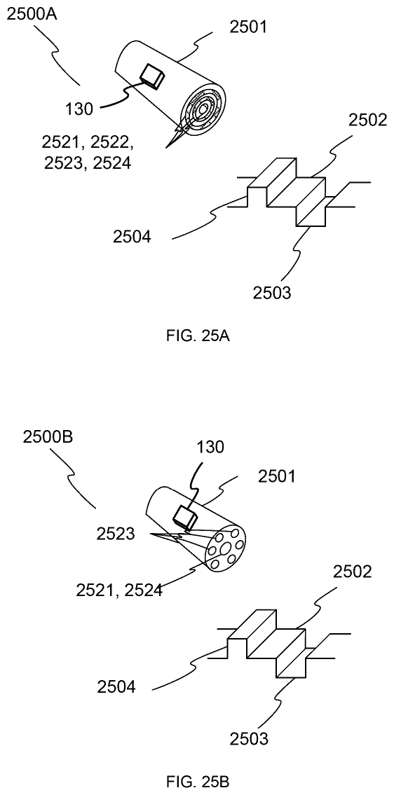

FIG. 24 is a perspective pictorial and block diagram illustrating an embodiment depicting details of an apparatus 2400 having a sensor head 2405 that includes plurality of light sources 2403 of different wavelengths such as light emitting diodes (LED) or a laser diode, oriented in horizontal and in vertical directions, and a structure, object or a surface 2402 being tested. Reflected or scattered light from the object or a surface 2402 is captured by the image capturing device such as camera 2401. The apparatus 2400 can also include a registration sensor 130.

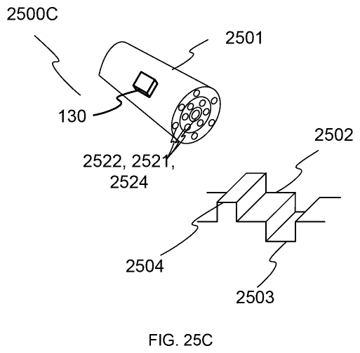

FIGS. 25A to 25C depict various systems 2510A, 2500B, and 2500C with each having sensor heads or inspection head configurations 2501 for inspecting surfaces 2502. The light sources 2523 and optical components such as light emitting diodes, lasers, filters and polarizers 2522, and image capturing devices such as single and multi-element detectors 2524 and imagers 2521 can be configured in various arrangements. FIGS. 25A to 25C depict inspection of object or surface 2502 with protrusions 2504 and indentations such as grooves, notches, dents, or cracks 2503. The sensor head 2501 can be either normal to the inspection surface 2502, or at any arbitrary angle of incidence. The systems 2500A, 2500B, and 2500C can also include a registration sensor 130.

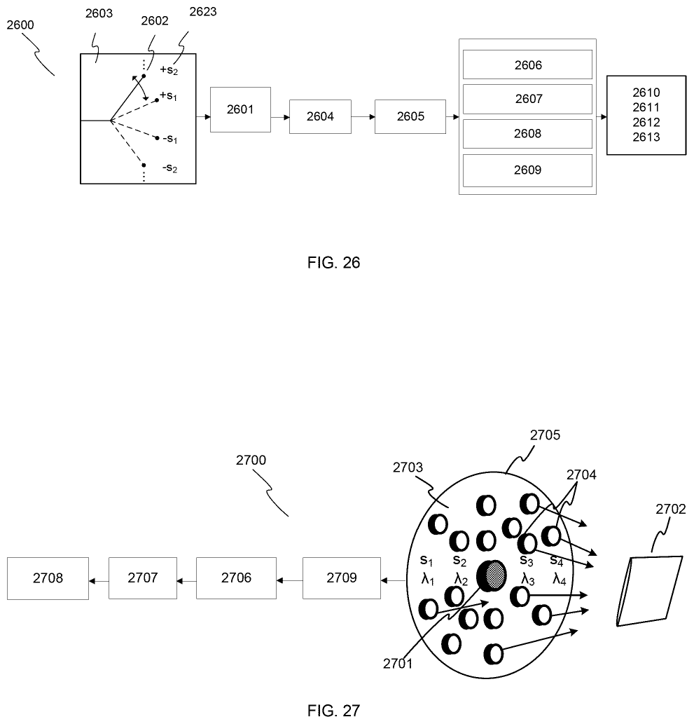

FIG. 26 is a perspective pictorial block diagram illustrating steps for detecting height and depth of a feature or defect using various methodologies and apparatus described herein. The system 2600 includes light sources 2623 are turned on-off using a source control 2603 which is made up of one or more switches 2602 that control the light sources 2623. Source outputs go through a series of detections starting via an image capturing device such as a detector or camera 2604 that is included in the sensor head 2601 and a generated signal is digitally processed using a processor 2605. Various elements of the processed signal are further analyzed, such as the signal width 2606, signal amplitude 2607, signal phase, namely signal edge position 2608, and signal direction compared to background signal level 2609, which can be either positive or negative. For depth and height determination, this analysis is performed around the features. The elements of the processed signal result in detection 2610 of a feature or defect, its depth or height 2611, width 2612, and the topographic orientation 2613, whether it is a protrusion or indentation. It should be obvious to those skilled in the art that two-dimensional data from a camera can be converted to a line scan to perform the measurements described herein, or the processing can be performed directly on the two-dimensional camera data using various digital signal and image processing computations and using matrix computation for rapid processing.

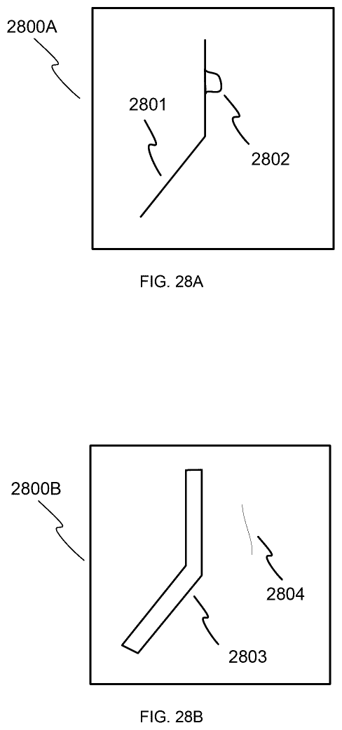

FIG. 27 is a perspective pictorial block diagram that illustrates how detection of source wavelength enables determination of which light source illuminates the structure or object 2702. Determination of the light source 2704 enables determination of angle of incidence, which is then used to determine height or depth of a feature or defect. FIG. 27 depicts a sensor head 2705 that includes a single or a plurality of single or multi-wavelength light sources 2704 and an image capturing device such as a camera or a detector 2701 that may also include filters, such as spatial filter, wavelength filters, or polarization filters. The output of the sensor head goes to a pre-processor 2709 that results in an image and indicates the wavelength 2706 of the source used. Multiple wavelength outputs are correlated to pre-determined angles as determined by the location or position 2707 of the light source 2704. Knowledge of the wavelength enables determination of which of the light sources 2704 is used to illuminate the structure or object 2702. Therefore, location or position 2707 of the light source 2704 is determined using a registration sensor 130 (FIG. 24). In doing so, illumination angle of incidence is determined, which enables depth and height measurements as described herein. The source position information is fed to processor 2708. Therefore, each source can result in multi-wavelength detection and multi-angle detection simultaneously.

FIG. 27 configuration allows for a faster scan by simultaneously turning on light sources 2704 such as multiple sources and multi-element LEDs and by detecting image of the structure or object 2702 from different wavelengths using image capturing devices such as single or multiple detectors with embedded filters. This simultaneous detection of wavelength using source and detectors/imagers enables faster detection compared to each source sequenced serially and can then be sent to processing 2708. Therefore, a scheme of utilizing multi-wavelength light sources 2704 enables faster detection by use of parallel measurements, as described herein.

In some embodiments similar to FIG. 27, the light sources 2704 are of different positions and wavelengths, 2703. In other embodiments either a single or multiple cameras or defectors are used. Yet in other embodiments filters are used in front of the camera or detector 2701.

In some embodiments similar to FIG. 27 multi-wavelength light sources and multi-wavelength detectors are used in conjunction with single or multiple (plurality) of cameras or detectors, or a combination thereof.

In other embodiments similar to FIG. 27 using multi-wavelength light sources and multi-wavelength imagers, cameras or detectors, light sources are sequenced serially, in parallel, or a combination thereof.

It should be obvious to those skilled in the art, that instead of wavelength, other parameters can be controlled similar to the configuration shown FIG. 27, such as using multiple polarization states. In this arrangement, instead of using multiple wavelengths, each sensing element represents a different polarization state. This is achieved using a polarization filter in front of each sensor. Single or multiple cameras or detectors can be used with a polarizer placed in front of them. The signal amplitude from the camera can vary based on which source is turned on. Therefore, this allows for simultaneous detection of polarization and determination of which source is used. Also, this allows for determination of incident light position, and therefore its angle of incidence, which is then used to determine depth or height of feature or defect as described herein.

In some embodiments similar to FIGS. 23, 24, 25A, 25B, 25C, 26 and 27, and in various embodiments described herein, using signal from multiple angle measurements using multiple light sources enables an increase in signal-to-noise ratio compared to using a single source. This enhancement can be achieved using various signal and image processing techniques, such as i) differentiation, ii) division, iii) detection of difference between signature from different sources, iv) spatial frequency measurements such as Fourier transformation, v) convolution, correlation, vi) using neural computing such as using neural networks, or any other signal or image processing techniques, or any combination thereof.

In some embodiments similar to FIGS. 23, 24, 25A, 25B, 25C, 26 and 27, using measurements from multiple wavelength light sources and detectors, and obtaining spectral characteristics results in an increase in signal-to-noise ratio compared to using a single source. This enhancement can be achieved using various signal and image processing techniques, such as i) differentiation, ii) division, iii) detection of difference between signature from different sources, iv) spatial frequency measurements such as Fourier transformation, v) convolution, correlation, vi) using neural computing such as using neural networks, or any other signal or image processing techniques, or any combination thereof.

In some embodiments similar to FIGS. 23, 24, 25A, 25B, 25C, 26 and 27, using measurements from multiple polarization sources and detectors, and obtaining polarimetry measurements results in an increase in signal-to-noise ratio compared to using a single source. This enhancement can be achieved using various signal and image processing techniques, such as i) differentiation, ii) division, iii) detection of difference between signature from different sources, iv) spatial frequency measurements such as Fourier transformation, v) convolution, correlation, vi) using neural computing such as using neural networks, or any other signal or image processing techniques, or any combination thereof.

In other embodiments similar to FIGS. 23, 24, 25A, 25B, 25C, 26 and 27, using a signature from multiple angle measurements, multiple wavelength measurement, multiple polarization measurements, or a combination thereof, results in an increase in signal-to-noise ratio compared to using a single source measurement. This enhancement can be achieved using various signal and image processing techniques, such as i) differentiation, ii) division, iii) detection of difference between signature from different sources, iv) spatial frequency measurements such as Fourier transformation, v) convolution, correlation, vi) using neural computing such as using neural networks, or any other signal or image processing techniques, or any combination thereof.

In various embodiments described herein, signal calculations, detection and signal and image enhancement can be achieved using various signal and image processing techniques, such as i) differentiation, ii) division, iii) detection of difference between signature from different sources, iv) spatial frequency measurements such as Fourier transformation, v) using wavelet transforms, vi) convolution, correlation, vii) morphological image processing such as dilation and erosion operations, viii) using neural computing such as using neural networks, or any other signal or image processing techniques, or any combination thereof.

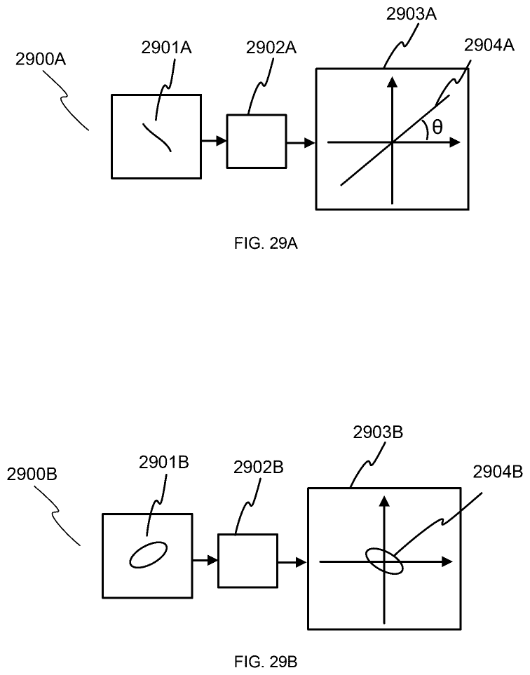

To speed up defect detection and classification, it is necessary to distinguish between different types of defects, such as a linear or circular defect, as depicted in FIG. 28A, where a linear feature or defect 2801 such as a crack, and a circular or elliptical feature or defect 2802 are adjacent to each other and are captured simultaneously in the same image of the camera.

Furthermore, to speed up defect detection and classification, it is necessary to distinguish between different sizes of features or defects, such as for wide features such as a gap or indentation 2803 or a narrow feature 2804 such as a thin crack as depicted in FIG. 28B.

To rapidly capture and distinguish and classify between different types and sizes of defects and features, several signal and image processing methods are utilized as described herein. One of the processing techniques is depicted in FIGS. 29A and 29B using spatial frequency analysis, such as using Fourier transforms. With respect to system 2900A, when a linear feature in the pre-processed image 2901A described herein undergoes spatial frequency transformation, such as a Fourier transform 2902A, it will produce a line pattern 2904A in the spatial frequency domain 2903A, as depicted in FIG. 29A. With respect to system 2900B, when a circular or elliptical feature in the pre-processed image 2901B described herein undergoes spatial frequency transformation, such as a Fourier transform 2902B, it will produce a circular or elliptical pattern 2904B in the spatial frequency domain 2903B, as depicted in FIG. 29B. When both linear and elliptical features are present, the spatial frequency will contain both linear and elliptical patterns, both in the orthogonal direction in the perspective patterns. This spatial frequency map reveals the types of defects or features present, and further analysis can be achieved by further filtering the spatial frequency information to extract either liner or circular features, thus enabling classification of the input image data.

Furthermore, the spatial frequency analysis can also be used to distinguish between different sizes of features or defects, such as for wide features such as a gap or indentation 2803 or a narrow feature 2804 such as a thin crack as depicted in FIG. 28B. This is achieved by analyzing the spatial frequency data. Namely, narrow features create wide spatial frequency data, whereas wide features create narrow spatial frequency data.

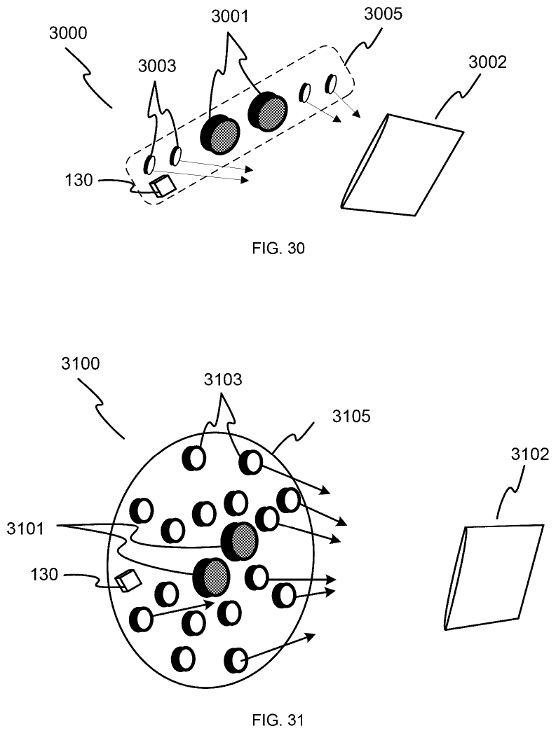

FIG. 30 is a perspective pictorial and block diagram illustrating an embodiment depicting details of system 3000 having a sensor head 3005 that includes plurality of light sources 3003 of different wavelengths such as light emitting diodes (LED) or a laser diode, and a structure, object or a surface 3002 being tested. The apparatus 3000 can also include a registration sensor 130. Reflected or scattered light from the specimen is captured by two or more image capturing devices such as cameras 3001. In some embodiments, each of the light sources 3003 is a different wavelength, or consists of multiple elements of different wavelengths, or a combination thereof. In other embodiments, the light sources 3003 are the same wavelength. The light sources 3003 are sequentially turned on using switches such as switches 2602 (FIG. 26) while cameras 3001 are capturing the signal, or turned on simultaneously, or a combination thereof. The cameras 3001 are either a monochromatic camera and determines which light source 3003 turns on via timing of the light source trigger signal, or cameras that have multiple channels of different wavelength outputs. The fact that each light source 3003 is of different wavelength enables determination of which light source 3003 is on by use of light source timing signal, but also when multiple light sources 3003 of different wavelengths are turned on simultaneously, various output channels of the camera images result from the corresponding illumination of a particular light source 3003. This parallel approach significantly enhances the speed of detection. For example, if three light sources 3003 of three different wavelengths are turned on in parallel, and detected by three channels of the camera 3001, then the capture rate is three time faster than using a single channel approach.

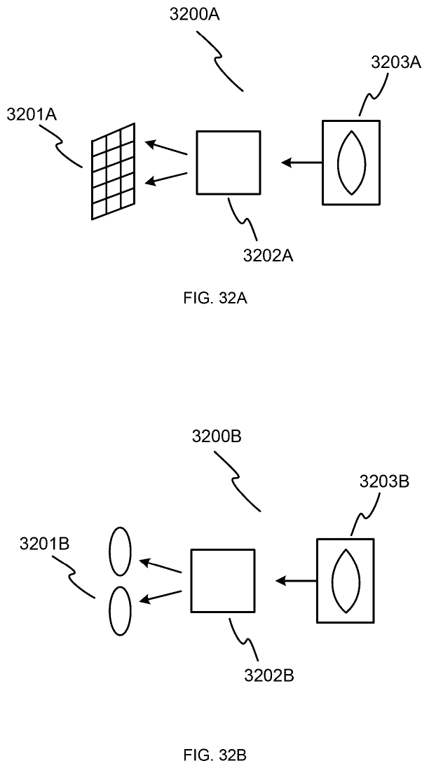

FIG. 31 is a perspective pictorial and block diagram illustrating an embodiment depicting details of a system 3100 having a sensor head 3105 that includes plurality of light sources 3103 of different wavelengths such as light emitting diodes (LED) or a laser diode, oriented in horizontal and in vertical directions and object or a surface 3102 being tested. The apparatus 3100 can also include a registration sensor 130. Reflected or scattered light the object or specimen surface is captured by two or more image capturing devices such as cameras 3101. In some embodiments similar to FIG. 31, cameras 3101 are placed in one direction, such as in horizontal direction. In other embodiments similar to FIG. 31, cameras 3101 are placed in multiple directions, such as in horizontal and vertical direction, and at various orientations, such that multiple images of different angular perspective are generated in all directions. In some embodiments, each of the light sources 3103 is a different wavelength, or consists of multiple elements of different wavelengths, or a combination thereof. In other embodiments, the light sources 3103 are the same wavelength. The light sources 3103 are sequentially turned on using switches such as switches 2602 (FIG. 26) while cameras 3101 are capturing the image, or turned on simultaneously, or a combination thereof. The cameras 3101 are either a monochromatic camera and determines which light source 3103 turns on via timing of the light source trigger signal, or a camera that has multiple channels of different wavelength outputs. The fact that each light source 3103 is of different wavelength enables determination of which light source 3103 is on by use of light source timing signal, but also when multiple light sources 3103 of different wavelengths are turned on simultaneously, various output channels of the camera images result from the corresponding illumination of a particular light source 3103. This parallel approach significantly enhances the speed of detection. For example, if three sources 3103 of three different wavelengths are turned on in parallel, and detected by three channels of the camera, then the capture rate is three time faster than using a single channel approach. Therefore, depth or height detection is detected either by means of multiple angular illumination, imaging at different angular perspectives, or a combination thereof.

As depicted in FIGS. 30 and 31, images captured by the two or more cameras 3001 and 3101 enable height and depth determination. Each image is captured from a slightly different perspective, namely optical light path of the two cameras are tilted with respect to each other. This tilt produces image shift, which then allows computation of height or depth by geometric means, as described herein.

Furthermore, in FIGS. 30 and 31 apparatus, height and depth is measured either using different illumination angles generated by using multiple light sources 3003 and 3103, using multiple shifted images from multiple cameras 3001 and 3101, or a combination thereof. Using multiple depth determination methods and digitally combining the results enables a significant increase in the detection of signal-to-noise ratio and therefore an increase in the accuracy of height or depth measurement.

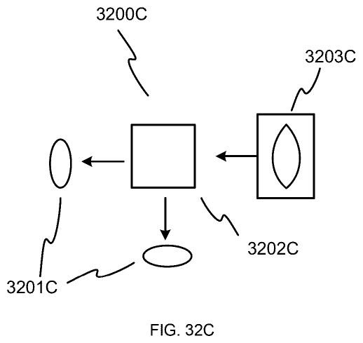

FIG. 32A depicts an apparatus 3200A having a beam splitter or splitting optics 3202A that direct scattered or reflected light from an object to plurality of directions toward the image capturing device such as camera or detector array 3201A. The apparatus may use focusing optics 3203A to image the object onto an image capturing device such as single detector array or camera 3201A. The beam splitter or splitting optics is set such that one or both of the images are shifted with respect to each other spatially. Namely, shift is introduced in one or both of the light paths from the optical axis, such that a double image is generated and captured by camera or detector array 3201A. Each image is slightly shifted with respect to each other. The detector array or camera captures two images, each emanating from two slightly different angular directions. The double-shifted images enable depth or height measurement by digitally analyzing the shift and extracting depth or height information as described herein. In some embodiments similar to FIG. 32A, instead of using focusing optics 3203A, focusing optics that are attached to the camera or detector array 3201A focuses the image of the object. In other embodiments similar to FIG. 32A, a combination of focusing optics 3203A and an additional focusing optics attached to the camera or detector array 3201A images the objects onto the camera or detector array 3201A. Yet in other embodiments similar to FIG. 32A, image shifting is achieved using optics that enables image shifting, such as a lens offset from the optical axis. In some embodiments, the shifting optics may be incorporated in the beam splitting optics 3202A.

FIG. 32B depicts an apparatus 3200B having a beam splitter or splitting optics 3202B that direct scattered or reflected light from an object to plurality of directions towards image capturing device such as cameras or detector arrays 3201B. The apparatus 3200B may use focusing optics 3203B to image the object onto a two or more detector arrays or cameras 3201B. The beam splitter or splitting optics 3202B is set such that one or both of the images are shifted with respect to each other spatially. Namely, shift is introduced in one or both of the light paths from the optical axis, such that images from the two cameras or detector arrays 3201B are slightly shifted. Each detector array or camera 3201B captures an image, each emanating from two slightly different angular directions. The two shifted images enable depth or height measurement by digitally analyzing the shift and extracting depth or height information as described herein. In some embodiments similar to FIG. 32B, instead of using focusing optics 3203B, focusing optics attached to the cameras or detector arrays focuses the image of the object. In other embodiments similar to FIG. 32B, a combination of focusing optics 3203B and an additional focusing optics attached to the cameras images the objects onto the cameras or detector arrays 3201B. Yet in other embodiments similar to FIG. 32B, image shifting is achieved using optics that enables image shifting, such as a lens offset from the optical axis. In some embodiments, the shifting optics may be incorporated in the beam splitting optics 3202B.

FIG. 32C depicts an apparatus 3200C having a beam splitter or splitting optics 3202C that direct scattered or reflected light from an object to plurality of directions, such as in orthogonal directions, toward image capturing devices such as two cameras or detector arrays 3201C. The apparatus 3200C may use focusing optics 3203C to image the object onto the detector array or camera 3201C. The beam splitter or splitting optics 3202C is set such that one or both of the images are shifted with respect to each other spatially. Namely, shift is introduced in one or both of the light paths from the optical axis, such that images from the two cameras or detector arrays 3201C are slightly shifted. The shifted images enable depth or height measurement, namely by digitally analyzing the shift and extracting depth or height information as described herein. In some embodiments similar to FIG. 32C, instead of using focusing optics 3203C, focusing optics attached to the cameras or detector arrays focuses the image of the object. In other embodiments similar to FIG. 32C, a combination of focusing optics 3203C and additional focusing optics attached to the cameras images the objects onto the cameras or detector arrays 3201C. Yet in other embodiments similar to FIG. 32C, image shifting is achieved using optics that enables image shifting, such as a lens offset from the optical axis.

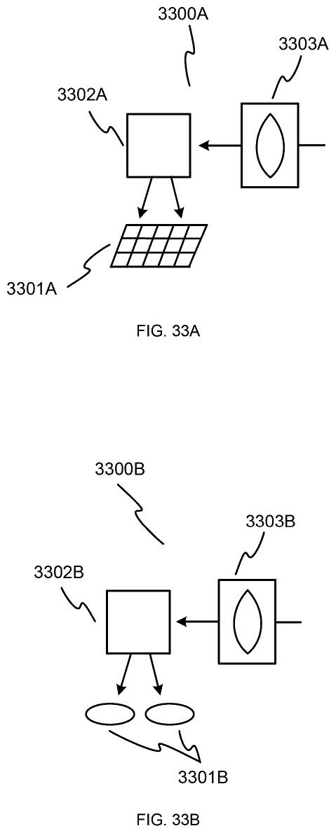

FIG. 33A depicts an apparatus 3300A having a beam splitter or splitting optics 3302A that direct scattered or reflected light from an object to plurality of directions toward an image capturing device such as a camera or detector array 3301A. The apparatus may use focusing optics 3303A to image the object onto a single detector array or camera 3301A. The beam splitter or splitting optics is set such that it reflects or directs light in a different direction, such as at or near 90 degrees from the optical axis, and it contains optical elements that enable multiple images generating that are shifted with respect to each other spatially. An example of this is using a double beam splitter or splitting light from two different surfaces of non-parallel glass, or a coated non-parallel glass. Namely, shift is introduced in one or both of the light paths from the optical axis, such that images from the two cameras or detector arrays 3301A are slightly shifted. The detector array or camera captures a double image, each emanating from two slightly different angular directions. The double-shifted images enable depth or height measurement, namely by digitally analyzing the shift and extracting depth or height information as described herein. In some embodiments similar to FIG. 33A, instead of using focusing optics 3303A, focusing optics attached to the camera or detector array focuses the image of the object. In other embodiments similar to FIG. 33A, a combination of focusing optics 3303A and an additional focusing optics attached to the camera images the objects onto the camera or detector array 3301A. Yet in other embodiments similar to FIG. 33A, image shifting is achieved using optics that enables image shifting, such as a lens offset from the optical axis. In some embodiments, the shifting optics may be incorporated in the beam splitting optics 3302A.

FIG. 33B depicts an apparatus 3300B having a beam splitter or splitting optics 3302B that direct scattered or reflected light from an object to plurality of directions toward image capturing devices such as two cameras or detector arrays 3301B. The apparatus 3300B may use focusing optics 3303B to image the object onto a two or more detector arrays or cameras 3301B. The beam splitter or splitting optics 3302B is set such that it reflects or directs light in a different direction, such as at or near 90 degrees from the optical axis, and it contains elements that enable multiple image generating that are shifted with respect to each other spatially. Namely, shift is introduced in one or both of the light paths from the optical axis, such that images from the two cameras or detector arrays 3301B are slightly shifted. Each detector array or camera 3301B captures an image, each emanating from two slightly different angular directions. The two shifted images enable depth or height measurement, namely by digitally analyzing the shift and extracting depth or height information as described herein. In some embodiments similar to FIG. 33B, instead of using focusing optics 3303B, focusing optics attached to the camera or detector array focuses the image of the object. In other embodiments similar to FIG. 33B, a combination of focusing optics 3303B and additional focusing optics attached to the camera images the objects onto the camera or detector array 3301B. Yet in other embodiments similar to FIG. 33B, image shifting is achieved using optics that enables image shifting, such as a lens offset from the optical axis. In some embodiments, the shifting optics may be incorporated in the beam splitting optics 3302B, in the lens attached to the camera, or a combination thereof.

In some embodiments similar to FIGS. 32A, 32B, 32C, 33A and 33B, image shifting and splitting is achieved using reflective, diffractive, refractive or polarizing optics, or a combination thereof. In other embodiments similar to FIGS. 32A, 32B, 32C, 33A and 33B, image shifting and splitting is achieved using a multi-component imaging lens or a lens array such that it generates two or more images, each shifted with respect to each other. One example of this is using two or more lenses shifted spatially orthogonal to the optical axis. Another example of this is using two or more lenses shifted spatially orthogonal to the optical axis and tilted with respect to each other.

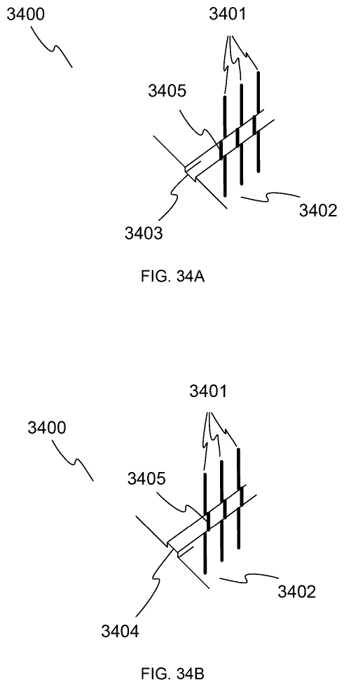

FIGS. 34A and 34B depict a system 3400 that illustrates various examples of projection patterns 3401 generated by the projection pattern generator 1800 depicted in FIGS. 18,19, 20, 21 and 22 that can also be used for depth and height measurement. This is achieved by the camera (or cameras) or image capturing device (or image capturing devices) described herein that detect the shifted projected pattern 3405. The direction of the projected pattern shift 3405 depends on whether it is lower than the surround inspected surface 3402, such as an indentation, a groove a notch, or a dent 3403 (FIG. 34A) or higher than the surround inspected surface 3402, such as a protrusion 3404 (FIG. 34B). The projected pattern amount of shift, namely the deviation from its original pattern depends on the height or depth of the feature or defect. Namely, the deeper the indentation, or higher the protrusion, the larger the shift. Therefore, the amount of shift and the direction of the shift indicate the height or depth, and if it is a protrusion or indentation.

It should be obvious to those skilled in the art that any pattern, such as a linear pattern, circular pattern, and any arbitrary shaped pattern can be used to detect height and depth as described herein by means of detecting the deviation of the projected pattern from its original form due to indentations and/or protrusions. It should also be obvious to those skilled in the art that the deviation or change of the projected pattern, namely the shift of the projected pattern can be analyzed using various signal and image processing techniques, such as i) differentiation, ii) division, iii) detection of difference between original pattern and shifted pattern, iv) using calibrated images by projecting the pattern onto a flat surface, v) spatial frequency measurements such as Fourier transformation, vi) convolution, vii) correlation, viii) using neural computing such as using neural networks, or any other signal or image processing techniques, or any combination thereof.

### Technical Approach

### i) Ring Illumination Angular Scanning

FIGS. 1A and 1B illustrate light sources 123 and 125 such as light emitting diodes (LED), laser or optical fibers positioned as a ring on the outer edge of the sensor unit such that they produce an illumination at different radial angles of incidence. A camera 121 at the center of the device captures the light image from surface that is being inspected. Each light source covers a narrow range of radial angles, and a combination of multiple light sources produce a full range of angular measurements as depicted in FIGS. 1A and 1B. The light sources are rapidly sequenced to produce multi-radial scan images captured by the camera.

Defects such as pinholes, scratches, missing or damaged coating, and areas with chips, scratches and cracks have different angular reflection characteristics than surrounding smooth coating areas. Therefore, the scanning radial illumination measurements reveal these defects. For example, a non-damaged surface produces angle of reflection θᵣ, that is equal to angle of incidence, θᵢ. Namely θᵢ=θᵣ. Local variations in coating surface angles due to defects produce brightness variations in the image. Additionally, non-smooth surfaces produce reflection/scattering at wider range of angles.

For example, when there is a missing portion of the coating, reflection from the coated layer and the underlying layer will have different reflectivity. This difference has specific angular sensitivity and by scanning various angles of incidence, the optimal signal is obtained. It should be noted that reflected image for each radial angle (θᵣ) illuminated image, I_{R}(x, y, θᵣ), reveals the directionality of the defect with respect to the illumination angle, and provides critical knowledge of the defect location and orientation. For a quality assurance however, and overall defect map can be obtained, I_{RTot}(x,y), by integral all the angular scans, namely:

$${I}_{{R}_{Tot}} ( x , y ) = \int {I}_{R} ( x , y , {θ}_{r} ) d {θ}_{r} \qquad ( Eq . 1 )$$

Furthermore, small differences between the coated and damaged areas are revealed by comparing various angular scans. Digitally this is achieved using one of several digital processing techniques, such as comparing normalized difference between two or more images, performing correlation or convolution in the spatial domain, or multiplication in the Fourier domain.

FIGS. 8A and 8B depict a scanning illumination principle. FIG. 8A depicts defect detection on a metal surface coated with gray paint. Scratches and pinholes are present on the coated surface, some are deep enough to penetrate to the metal and others are shallow scratches only on the surface of the coating. Sequential angular illumination scanning and digitally processing reveals a wide variety of detects as depicted in FIG. 8A, from large areas 805 where paint is removed, to pinholes 803 and shallow scratches 804 on the surface. In contrast, if a single-source illumination imaging was used, only large scratches would be revealed. FIG. 8B depicts defect detection on a black plastic plate coated with a black paint that contains shallow and deep defects. The scanning illumination method reveals a wide range of defects as depicted in FIG. 8B. Even if the substrate and coating are the same color, angular illumination scanning reveals a variety of defects of different size and depth.

### ii) Differential Polarization Imaging

Polarization measurements can distinguish between different types of surface finish or surface angle and reveal damaged coating or distinguish a coated surface and an area with coating removed. Parallel and perpendicular polarized light have different reflectivity for a dielectric surface, and this difference depends on the angle of incidence. Using two polarization states, such as vertical- and horizontal-linear polarization states, or right- and left-handed circular polarization states, will reveal differences in surface finish and defects, particularly when images obtained from the two states are subtracted as demonstrated. Two or more polarization state measurements are achieved by several methods, such as using rotating polarizers in front of a camera, using two cameras next to each other with polarizers placed in front of them at vertical and horizontal orientation, or using a polarization beam splitter directing light to two different cameras, or polarization control devices such liquid crystal light valves, or any other polarization control devices.

Polarization detection often requires large angles. For a dielectric surface, angles in the vicinity of 57° of incidence would work optimally. This however requires either having the sensor unit very close to the surface or having a source and a detector that are far apart. In order to enable a compact sensor apparatus that can work in a wide range of distances (e.g., from few inches to few feet from the surface being inspected), then differential polarization can be utilized. Namely, instead of using a single polarization state, two or more polarization states are used. For example, s- and p-polarization states are used, and image differences between the two states are calculated. This approach increases signal to noise ratio drastically, thereby allowing detection at smaller angles of incidence, and therefore a compact sensor apparatus works in a wide range of distances from the surfaces.

FIGS. 9A and 9B depict polarization-based defect detection to illustrate discrimination between two different surfaces, such as an underlying layer and an outer coating paint. A rectangular section 902 of a flat gray painted surface 901 has a polished section to mimic different surfaces that have different reflectivities than the coating. This may also represent damage to a surface. Using conventional photography, the polished section is not distinguishable from the rest of the sample as depicted in FIG. 9A. Using a differential polarization technique, however, clearly reveals the polished section as depicted in FIG. 9B. The dotted circles 903 in FIGS. 9A and 9B indicate the location of the polished section.

iii) Coherent Speckle Scanning

FIGS. 5A to 5D depict methods of generating coherent speckle illumination. Speckle noise is often a nuisance in coherent imaging applications. But it is the advantage of coherent illumination that very small variations in coating surface, such as voids and pits can be detected by utilizing speckle illumination. Because of its coherence characteristics, laser illumination results in speckle pattern when it passes through a diffuse media. Speckle size dependents on the random distribution of the diffuse media, and aperture size or the illumination spot incident on the coating media. When this diffuse illumination pattern is incident on a coating surface with areas that contain pits, voids, or small defects on the order of the speckle size, a very bright signal is detected by the camera viewing the illuminated part. Therefore, small defects can be detected by this method. Another method of generating speckle illumination is using a multi-mode fiber as depicted in FIG. 5B.

The captured image using speckle illumination however will be very noisy, which is a characteristic of coherent illumination. To reduce speckle noise from the image while maintaining the advantage of coherent detection, either the random media, or the multi-mode fiber are moved as depicted in FIGS. 5A-5D to smooth the detected image.

FIGS. 10A-10C illustrate detection of defects using speckle illumination on metal plate coated with paint and having small defects. Speckles are generated by a laser light incident on a moving diffuser as indicated in FIGS. 5A-5D, and speckle size is controlled by the illumination aperture. Two speckle sizes illuminations are compared, one coarse and the other fine. For small defects, fine speckles result in better detection of the defects than coarse speckle illumination as depicted in FIG. 10B and FIG. 10C.

Coherent illumination will generate an image that is full of speckle noise which makes it difficult to separate the signal from the defective area from noise. To overcome this, a speckle noise reduction technique using a rapidly moving diffuser or moving a multi-mode optical fiber is employed. Even though the speckle pattern is moving, it will still reveal the defects, but noise in the image will be significantly reduced.

FIGS. 11A-11B depict an example of speckle noise reduction techniques for image improvement. These techniques utilize either a moving scattering media or a vibrating multi-mode fiber-optic apparatus.

### iv) Multi-Spectral Imaging

Multi-spectral [ultraviolet (UV), visible and infrared (IR)] imaging detects defects by detecting differences between the spectral response on the structure surface or the surface coating and the damaged area, such as if the underlying layer is exposed. Multi-spectral measurements are achieved using a) multi-wavelength light emitting diodes (LEDs), laser diodes (LD) combined with monochrome cameras, b) using white light or broad spectral band light sources with multi-channel cameras with red, green, blue and infrared (IR) outputs, c) using multiple LD, LED sources, or broad spectral band light sources combined with filters, or a combination thereof. In some embodiments, the filter can be a fixed filter, or a tunable filter, such as a liquid crystal tunable filter, or a combination thereof. In other embodiments the light source can be turned on simultaneously, sequentially, or a combination thereof.

### v) Converting Scan Data to Defect Map

To register the defect position relative to surface features and the structure coordinates, a wireless position apparatus is used. Two or more wireless transmitters are placed at a prescribed location (either permanently placed in the inspection area or placed at a distance from a reference feature on the structure). Attached to the transceiver 110B is wireless transceiver 107B used to triangulate the position of the sensor. Using this method allows detection accuracy of a few centimeters. Position accuracy is further enhanced using other positioning sensors incorporated on the same positing electronics. An example of additional positioning sensor is using an ultrasonic transducer that measures distance from the sensor head 101 to the structure surface, optical distance measurement sensors, accelerometer and gyroscope-based position and orientation sensors. Measuring the distance between the sensor head 101 and the structure surface determines the size of the image.

In an alternative embodiment, the wireless transceiver 107B contains sensor that detects, pitches, yaw, or arbitrary angle. In some embodiments, an accelerometer-based sensor is incorporated to the sensor head.

The scanned data is transferred via an electrical wired connection or wireless communication (WiFi) and saved in a digital format which is then used to locate and repair the defects with ease. An electronic processor is used that enables position detection as well as data transfer of the sensor head scan data to a processing and display electronics.

A WiFi position detection unit such as wireless position receivers and transceivers (WiFi) 107 can be used to transfer captured data to structure coordinates. The WiFi position detection unit has a transmitter and receivers.

### vi) Additional Inspection Structures

FIG. 12 depicts sensor 1200 for inspecting surfaces 1202. It utilizes multiple optical modalities, where coherent and incoherent optical sources 1223 and components such as lasers and polarizer 1222 can be configured in various positions, either in a circular configuration, or in an arbitrary position within the sensor head 1201, combined with cameras and imaging components 1221 and single- or multi-element optical detectors 1224.

FIG. 12 is an overview of a sensor 1201. Multiple parameters are measured using i) scanning radial illumination 1203 by sequentially pulsing each light source and detecting each angle, ii) Coherent speckle illumination 1204 generated by a combination of laser diodes, and scattering media, to detect very small defects, and iii) multi-wavelength imaging 1205, where a combination of multi-wavelength LEDs are used for identifying defects in a structure surface, a surface coating, and an underlying material, and iv) polarization imaging 1206 using polarization components that are mounted in front of the camera, or using multiple adjacent cameras with polarizers oriented orthogonal to each other or at a different polarization angle from each other. The processor 1212 is composed of pre-processor 1219 to take raw sensor data, and combine the multiple inspection modalities, 1203, 1204, 1205 and 1206. Digital display 1213 shows the defect map 1214. Since multiple modalities are used, it is possible to classify each defect, and a single defect type or class, multiple defect types or classes, or all defect types or classes can be displayed by using a digital selection option 1227.

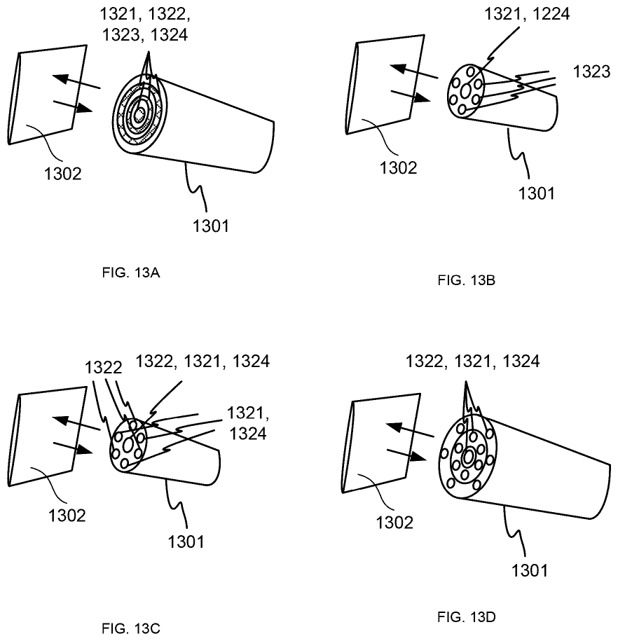

FIGS. 13A to 13D depict various sensor head or inspection head configurations 1301 for inspecting surfaces 1302. The sources 1323 and optical components such as light emitting diodes, lasers, filters and polarizers 1322, and single and multi-element detectors 1324 and imagers 1321 can be configured in various configurations. FIG. 13A depicts a generalized configuration, whereas FIGS. 13B to 13D depict example various sources and detector/image configurations.

vii) Adapting the Inspection Head to Various Surfaces

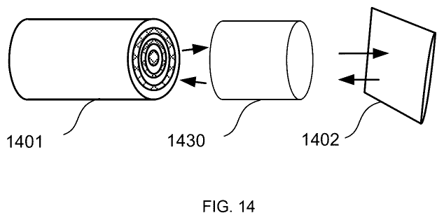

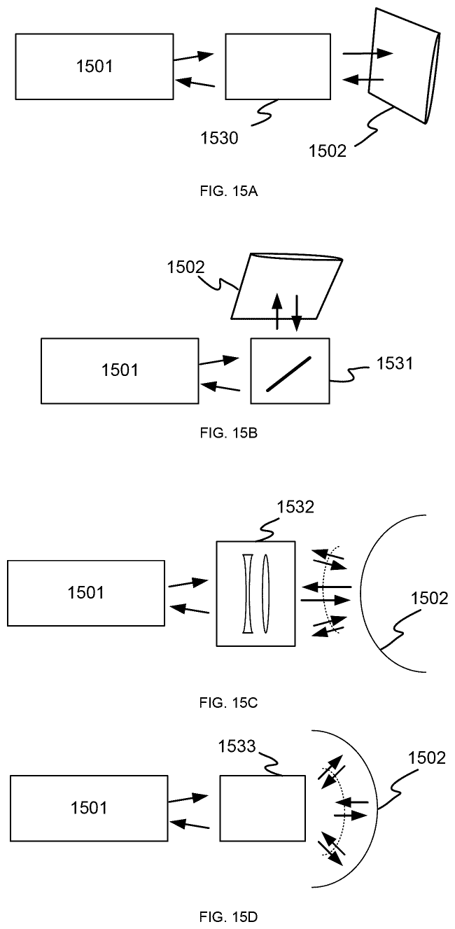

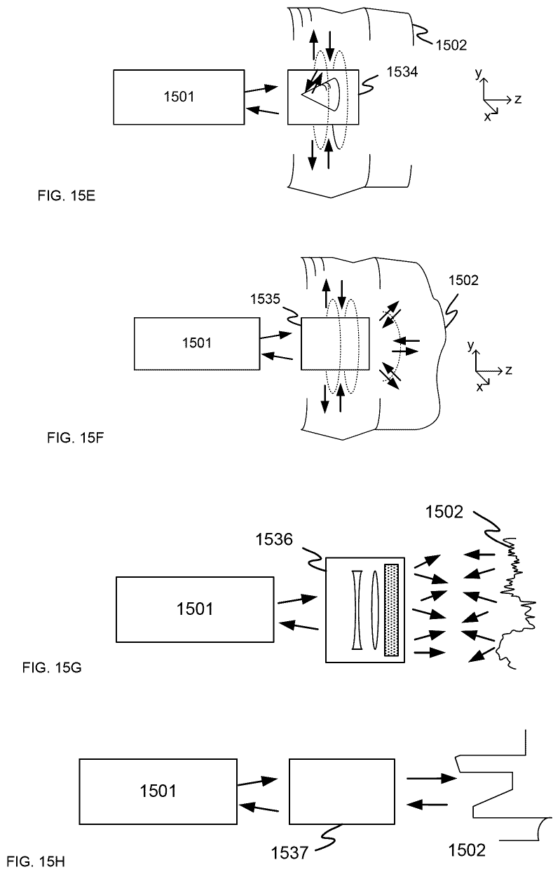

To achieve optimum inspection, an attachment is added to the sensor head to make the sensor operate optimally with a particular surface type. A generalized configuration of attaching additional optics or opto-mechanical apparatus is depicted in FIG. 14, and some examples are shown in FIGS. 15A to 15G.

FIG. 14 depicts a generalized configuration of attaching additional optics 1430 and an opto-mechanical apparatus to the sensor head 1401 to enable optimal illumination and detection configuration suitable for various types of surfaces 1402.

FIGS. 15A to 15H depict various configurations of attaching additional optics and an opto-mechanical apparatus to enable optimal illumination and detection configuration suitable to various types of specimens and surfaces.

FIG. 15A depicts an example attachment 1530 to the sensor head 1501 suitable for direct incidence inspection of a surface 1502. In this case normal incidence collimating optics 1530 is utilized. FIG. 15B depicts an example attachment 1531 suitable for angled incidence inspection, such as utilizing reflective optics for directing light in a specific direction. FIG. 15C depicts an example attachment 1532 suitable for a curved or concave surface inspection, where the light coming out of the optical attachment converges towards the specimen or the surface being inspected. FIG. 15D depicts an example attachment 1533 suitable for a curved or convex surface, where the light coming out of the optical attachment diverges towards the specimen. FIG. 15E depicts an example attachment 1534 suitable for inspecting at 360 degrees in radial (xy) direction, such as for inspecting inside a hollow structure or inside a tube or a pipe. Optical components inside the attachment 1534 direct and collect light at a 360° in a radial (xy) direction. Examples include conical mirrors or rotating reflective components. FIG. 15F depicts an example attachment 1535 suitable for inspecting at 360° in a radial (xy) direction, and in axial (xz and yz) directions, such as for inspecting inside a hollow structure or a deep hole. Optical components inside the attachment 1535 direct and collect light at a 360° in a radial (xy) direction and in axial (xz and yz) directions. FIG. 15G depicts an example attachment 1536 suitable for inspecting highly diffuse, rough, or scattering surfaces, where the light coming out of the optical attachment is suitable to generate and collect diffuse illumination. A combination of refractive or diffractive, and scattering optics are utilized. FIG. 15H depicts an example attachment 1537 suitable for inspecting parts and surfaces with deep structures and variations. In this case, the attachment 1537 utilizes long-working distance optics such as a telecentric lens.

The attachment optics in FIG. 14 and FIG. 15A to 15H are composed of one or more of reflective, refractive, diffractive, scattering, or a combination thereof. These components are used to control the direction of illumination and collection to achieve optimum sensing for different types of surfaces, as depicted in the figures. In addition, polarization components, spectral filtering, and spatial filtering components are also used to optimize detection for each surface.

It should be obvious to those skilled in the art that controlling the shape of the illumination and detection in the attachment optics in FIG. 15A to FIG. 15H can be achieved by using reflective, refractive, diffractive, and scattering optics, or a combination thereof.

The word specimen in these figures refers to inspected specimen, component, part, or surface of inspection. These words are used interchangeably throughout this application. The words sensor, sensor head, inspection head, sensor or sensing unit or inspection unit are used interchangeably throughout this application and in the various figures.

viii) Combining Multiple Inspection Modalities

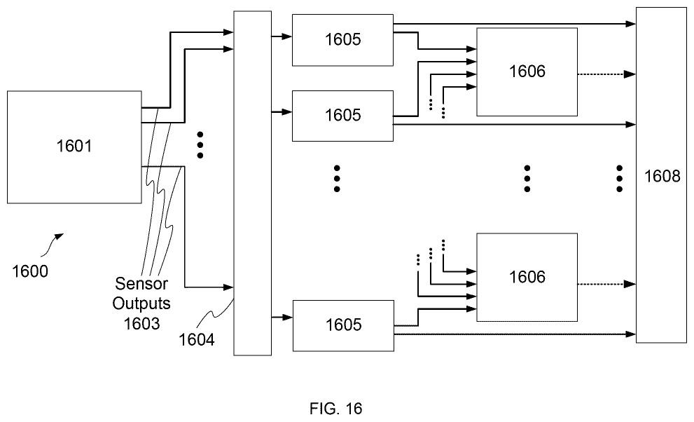

FIG. 16 is a pictorial block diagram illustrating a schematic of inspection unit 1600 for detecting defects using inspection apparatus 1601. Sensor outputs 1603 send signal and image data for processing that indicate various defect parameters. The outputs are either pre-processed 1604 digitally, or the raw sensor data is used, each corresponding to various inspection modalities 1605. Inspection modalities 1605 are combined to produce a defect map either individually or by combining with other modalities 1606. These modalities include multi-angle imaging, scanning radial illumination imaging, and polarization imaging, speckle illumination imaging, modulated speckle illumination imaging, multi-wavelength imaging, and spectral and temporal imaging, or a combination thereof. The combined output generates a defect map 1608.

### ix) Distortion Correction

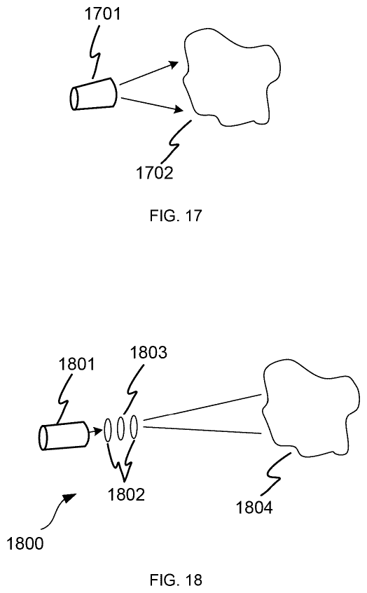

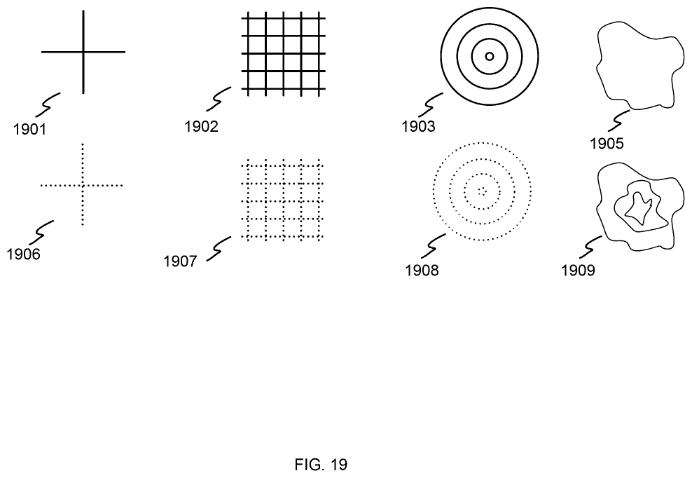

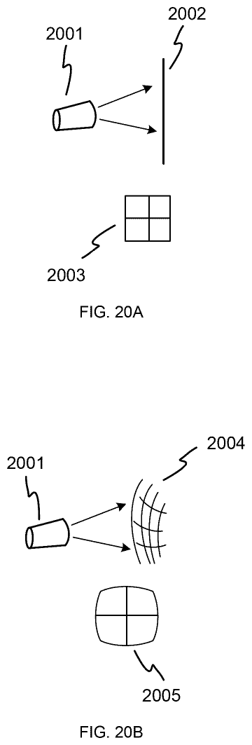

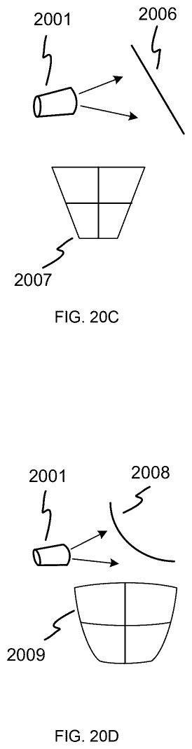

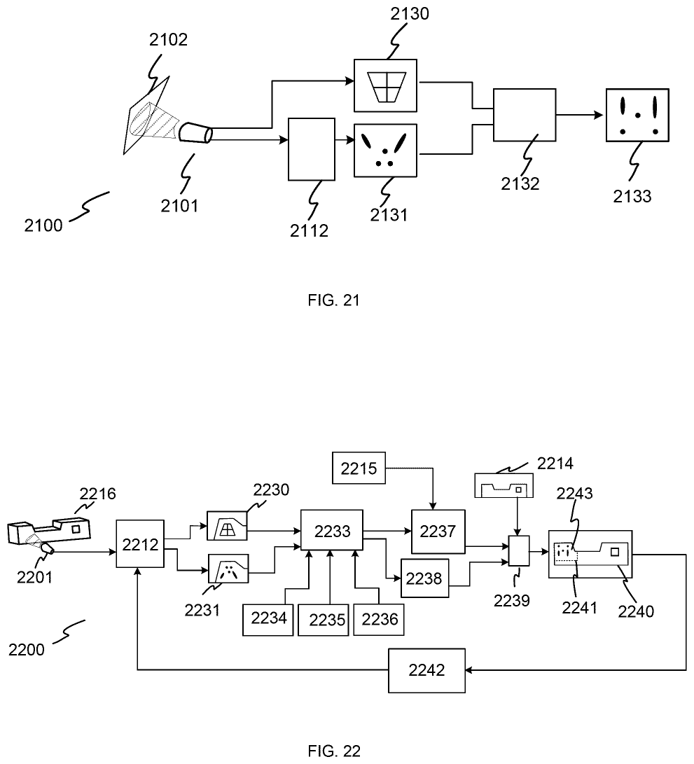

When the inspected surface is curved, is irregularly shaped, or if the sensor head 101 is at an angle of incidence with respect to the surface, then the defect map generated with the sensor head 101 depicted herein will be distorted. To correct for these distortions, image distortion correction is achieved by projecting a pattern onto the surface as depicted in FIG. 17, and then the image is digitally corrected. FIG. 18 illustrates a projection pattern generator for generating patterns such as those depicted in FIG. 19 onto various surfaces depicted in FIGS. 20A-20D. An image correction example is shown in FIG. 21. In some embodiments, image correction methods depicted in FIGS. 17-21 are combined with sensor head 101 position determination for distortion corrected defect mapping of the object or structure as depicted in FIG. 22.

FIG. 17 is perspective pictorial and block diagrams illustrating an embodiment for a sensor head 1701 that incorporates a projected pattern 1702 onto the inspected surface.

FIG. 18 is perspective pictorial and block diagrams illustrating an embodiment of a projection pattern generator 1800. Emission from a light source 1801 passes through optics 1802 and a pattern generation filter 1803 to produce a projected pattern 1804. In some embodiments, optical source 1801 is a laser. In other embodiments, optical source 1801 is a light emitting diode, a single mode or a multi-mode laser, a fiber-optic coupled light source, an incoherent light source, a coherent light source, or a combination thereof. Yet in other embodiments, the light source 1801 is comprised of white light, a monochromatic light, a multi-wavelength light source, including a light source emitting in ultra-violet, visible or infrared wavelengths, or a combination thereof. In some embodiments, the pattern generation filter 1803 is a diffractive optical element, a refractive optical element, a holographic optical element, a computer-generated hologram, a micro-patterned optical element, or a combination thereof. For example, a line pattern is generated either using one or more refractive cylindrical elements, or a periodic grating, or a combination of both. In some embodiments, the projected pattern 1804 contains a linear or linearly symmetric pattern. In other embodiments, the projected pattern 1804 contains a circular or circularly symmetric pattern. Yet in other embodiments, the projected pattern 1804 is a combination of a linear or linearly symmetric, and a circular or circularly symmetric shape. Yet in other embodiments, the projected pattern 1804 is of arbitrary shape or symmetry containing periodic or non-periodic shapes or a combination thereof. In some embodiments projection pattern generator 1800 uses multiple pattern generation filters 1803, such as using a combination of one refractive element to generate diffractive, or two diffractive elements, two refractive elements, or a combination thereof. For example, a line or a linear pattern is generated using a cylindrical refractive optical element and a diffractive optical element such as periodic grating to replicate the line pattern.

FIG. 19 depicts various examples of projection patterns generated by the projection pattern generator 1800 depicted in FIG. 18, such as a cross pattern 1901, a linear array 1902, a circular pattern 1903, arbitrary patterns 1905 and 1909, a dotted cross pattern 1906, a dotted linear array 1907, or a dotted circular pattern 1908 or arbitrary.

In some embodiments similar to FIG. 1D, the sensor head 101 contains a projection pattern generator 1800 depicted in FIG. 18 to enable accurate pointing and centering of the sensor head 101 towards the ground markers 125 and height markers 126.

FIG. 20A is a pictorial block diagram illustrating a sensor head 2001 containing pattern generator 1800 depicted in FIG. 18 and projecting a pattern onto a flat surface 2002. When the sensor head 2001 is normal to the flat surface 2002, the projected pattern appears as an undistorted projected pattern 2003.

FIG. 20B is a pictorial block diagram illustrating a sensor head 2001 containing pattern generator 1800 depicted in FIG. 18 and projecting a pattern onto a curved surface 2004 that results in curved surface, distorted pattern 2005.

FIG. 20C is a pictorial block diagram illustrating a sensor head 2001 containing pattern generator 1800 depicted in FIG. 18 and projecting a pattern onto a tilted surface 2006 that results in a tilted surface, distorted pattern 2007.

FIG. 20D is a pictorial block diagram illustrating a sensor head 2001 containing pattern generator 1800 depicted in FIG. 18 and projecting pattern onto a curved and tilted surface 2008 that results in a curved and tilted distorted pattern 2009.

FIG. 21 is a pictorial block diagram illustrating a schematic of inspection unit 2100 for detecting defects combined with a projected pattern for image distortion correction. The sensor head 2101 contains pattern generator 1800 depicted in FIG. 18 that projects a pattern onto the inspected surface 2102. A camera 2103 that is attached to the sensor head 2101 detects an optical image of the projected pattern 2130. If the inspected surface 2102 is titled with respect to the sensor head 2101 normal incidence, or if is not a flat surface, then the image of the projected pattern 2130 will appear to be distorted compared to a projected pattern resulting from a flat and non-tilted surface.

The sensor head 2101 also detects and generates surface defect map 2131 using a processor as described herein and depicted in various figures, such as the processor 112 depicted in FIG. 1A. If the inspected surface 2102 is titled with respect to the sensor head 2101 normal incidence, or if is not a flat surface, then the defect map 2131 is distorted with a similar distortion as the projected pattern 2130. The distortion of the defect map 2131 is corrected using a digital distortion correction 2132 that outputs a distortion corrected defect map 2133. Distortion correction is achieved by comparing the distorted image of the projected pattern 2130 to an undistorted image stored in the memory of the digital distortion correction 2132 apparatus. The correction steps that are utilized to correct the distortion of the projected pattern 2130 are applied to the distorted defect map 2131.

Furthermore, the size of the image of the projected pattern 2130 is dependent on the distance between the sensor head 2101 and the inspected surface 2102. When this distance is large, the detected projected pattern 2130 appears small, and when the distance is small, the detected projected pattern 2130 appears large. Therefore, the projected pattern reveals the distance between the sensor head 2101 and the inspected surface 2102. In some embodiments, the distance between the sensor head 2101 and the inspected surface 2102, measured using the projected pattern 2130 and measured using the distance measurement finder 108 depicted in FIG. 1A to 1C and discussed herein, are combined to increase the accuracy of distance measurement between the sensor head 2101 and inspected surface 2102.

In some embodiments, digital distortion correction is achieved by image transformation, such as projective image transformation, to map the distorted image to a new corrected image. It should be understood that image mapping is achieved using matrix computation and matrix transformation. In some embodiments, digital distortion correction includes distortion correction, image size correction, linear and non-linear image correction using linear algebraic calculations such as matrix multiplication, division, addition, and subtraction. In other embodiments, digital distortion correction is achieved using neural computation such as training a neural network to transform a distorted image to an expected image and applying the same computation steps to a defect map to produce a distortion free defect map.

FIG. 22 is a pictorial block diagram illustrating a schematic of inspection unit 2200 for detecting defects using inspection apparatus combined with a projected pattern for image distortion correction, combined with position determination to produce a defect map 2240 of the entire inspected object or structure 2216. The sensor head 2201 contains pattern generator 1800 depicted in FIG. 18 that projects a pattern onto the inspected surface. The sensor head 2201 is connected to control and processing electronics 2212.

At each inspection position along the surface of the object 2216, a defect map 2231 is produced by the control and processing electronics 2212. If the object surface is not flat, or if the sensor head 2201 is not normal to the object surface, then this results to a distorted defect map 2231. For the same reason, a distorted projected image 2230 is also produced. The distorted defect map 2231 and the distorted projected image 2230 are sent to an image processing and correction apparatus 2233 that performs image and defect map corrections as described herein, and produces a distortion corrected defect map 2238 for the scan area on the object 2216 that is incident on the sensor head 2201.

To produce a distortion-corrected defect map 2238, rotation and tilt correction 2234, image size correction 2235, and distortion correction 2236 are utilized in the image processing and correction apparatus 2233 by various methods described herein. The result is a distortion-corrected defect map 2238 of the field of view of the sensor head 2201.

Furthermore, inspection position data 2215 is used for an inspected area position determination 2237. Inspection position data 2215 is acquired by the methods depicted in FIGS. 1A, 1C, 1D and 1E, and described herein. In addition, a predetermined image such as composite image or a digital model 2214 of the entire object 2216 is used for inspected area position determination 2237. This position information and the distortion-corrected defect map 2238 are sent to a processor 2239 that combines position information and the defect map 2238. The output of this processor 2239 is a distortion-corrected defect map on object model 2240 that shows a distortion corrected defect map 2243 of scanned area 2241. This procedure is repeated as shown at 2242 for each section along structure 2201, thus resulting in a total object defect map that indicates the position of each defect on the surface of the object or structure 2201.

In some embodiments, image processing and correction apparatus 2233 and various processing and computing blocks depicted in FIG. 22 are composed of electronic hardware, where the processing is performed in a microprocessor. In other embodiments, image processing and correction apparatus 2233 and various processing and computing blocks depicted in FIG. 22 are composed of computing algorithm or software that are executed on computer hardware. Yet in other embodiments, image processing and correction apparatus 2233 and various processing and computing blocks depicted in FIG. 22 are composed of either electronic hardware, where the correction processing is performed in a micro-processor or a computing algorithm or software that is executed on computer hardware, or a combination thereof.

In some embodiments similar to FIGS. 17-22, the camera 2103 used to detect optical image distortion is also used for generating the defect map, as described herein.

### x) Height and Depth Determination

In some embodiments, depth or height of a feature or defect is determined by means of illumination angle of incidence, as depicted in FIGS. 23, 24, 25A, 25B, 25C, 26 and 27, and in various embodiments described herein. In other embodiments, depth or height of a feature or defect is determined by means of plurality of cameras or double images as depicted in in FIGS. 30, 31, 32A, 32B, 32C 33A and 33B and in various embodiments described herein. Yet in other embodiments, depth or height of a feature or defect is determined by means of illumination angle of incidence, by means of plurality of cameras, or a combination thereof.

Depth and height measurements are achieved using the following methods:

i) Using different angles of illumination, a shadow of the feature or defect is generated using various embodiments depicted in FIGS. 23, 24, 25A, 25B, 25C, 26, 27, and in other embodiments depicted herein. The width of the shadow, the intensity of the shadow, or a combination thereof, is dependent on the height or depth of the feature or defect, which is captured by a camera or detector array.

ii) Using two or more cameras or detector arrays, or a single camera or a detector array in combination of splitting optics, image shifting is achieved by viewing the defect or feature from two or more perspectives. This is depicted in various embodiments shown in FIGS. 30, 31, 32A, 32B, 32C, 33A, 33B, and in other figures depicted herein. The shifted images are either captured with a single camera or imaging array, namely a double image, or using two or more cameras or detector arrays. The amount of shift of a defect or feature of a particular height or depth is captured by calculating the difference between the shift of that feature, either with respect to surrounding objects, or with respect to the edge of the feature or defect. For example, analyzing the detected images of an indentation with a particular depth, the outside edge and inside edge of the indentation are shifted differently for the two images from different angles. This shift reveals the depth information by geometric means.

FIGS. 30, 31, 32A, 32B, 32C, 33A, 33B depict plurality of cameras for depth determination combined with multiple sources, as described herein. The multiple camera system enables determination of depth by means of the shifting of the image due to a difference in the viewing angle. Image shift is dependent on the separation of the cameras from the center of the sensor head, namely the optical axis, and the distance between the sensor head and the structure or object. The depth or height of defects or features is calculated by using angle of incidence of each the camera or imaging array. Having plurality of shifted images enables depth perception, and therefore depth measurement. Namely depth is calculated by lateral shift of the images, and by the predetermined angle of incidence of the image with respect to the camera. The deeper the object, the larger is the lateral shift.

It should be obvious to those skilled in the art that depth or height information is calculated using the knowledge of the shift in the cameras or imaging array with respect to each other, or the shift in the optics, and the distance between the sensor head and the inspected surface. This is achieved by means of geometric or trigonometric calculations, namely the lateral image shift and depth have the same trigonometric relation, or same ratio, as the lateral shift between the cameras and the distance between sensor head and object.

In some embodiments such as those shown in FIGS. 23, 25A, 25B, 25C, 26, 27 and in other figures depicted herein, where the width of the feature or defect is larger than the detection pixel size, such as two or more detection pixels wide, then the feature results in a dark region in the image adjacent to the edge of the feature. The width of this dark region is dependent on the illumination angles of incidence. This enables detection of depth or height of the feature or defect by geometry based on angle of incidence and height or depth of the feature. For example, a deeper groove will result in a wider dark region in the image compared to a shallow groove.

In other embodiments such as those shown in FIGS. 23, 25A, 25B, 25C, 26, 27 and in other figures depicted herein, where the width of the feature or defect is comparable to size or smaller than the detection pixel size, then the amplitude or value of the pixel is inversely proportional to the depth or height of the feature or defect, which can be used for depth/height determination. For example, a deeper groove will result in a darker pixel where the groove is present in the image, whereas a shallow groove will result in a lighter pixel.

Yet in other embodiments, depth/height determination is achieved using a combination of detecting width of dark region generated by the feature or defect, or by the amplitude of the pixels in the feature/defect area, or a combination thereof.

It should be obvious to those skilled in the art, that utilizing multiple depth or height detection methods enables increase in the accuracy of the measurements.

### xi) Topographic Orientation Determination (Protrusion or Dent/Groove/Notch/Crack)

Various embodiments describe detection height or depth of a feature or defect, which are also used to determine the topographic orientation of the defect or feature. For apparatus that utilize a single camera and multiple light sources illumination the object at various angles of incidence such depicted in FIGS. 23, 24 and 27, and in other embodiments depicted herein, the orientation of the shadow or the dark region with respect to the edge of the feature or defect reveal if the feature is a protrusion or an indentation. For example, a feature with a falling edge on the left side will be revealed by illuminating from the right side, which will cast a shadow on the left side of the edge. Therefore, illumination from the side opposite to the falling edge of the feature will create a detectable dark region. One of the key advantages of using multi-angle illumination is not only to enhance feature or defect detection as described herein, but also to reveal topographic orientation of the feature or defects.

FIG. 26 describes signal amplitude and phase are extracted with respect to background, namely the amplitude of a linear scan in an image, the peaks and valleys due to edge of features or defects, and the phase of the peaks and valleys in the line scan which enables extraction of the topographic orientation as described herein.

For apparatus that utilize a multiple cameras, or a single camera with shifted images, such depicted in FIGS. 30, 31, 32A, 32B, 32C, 33A, and 33B, and in other embodiments depicted herein, the width and the orientation of the shadow or the dark region with respect to the edge of the feature or defect reveal if the feature is a protrusion or an indentation. For example, a feature with a falling edge on the left side will be revealed by illuminating from the right side, which will cast a shadow on the left side of the edge. Therefore, illumination from the side opposite to the falling edge of the feature will create a detectable dark region. The position of the camera with respect to the illumination source therefore indicates direction of the feature or defect. Analyzing and comparing images from two or more cameras will further enhance topographic orientation determination by providing a multi-parameter verification.

In some embodiments, multi-angle illumination, capturing images from plurality of cameras, capturing shifted image using splitting optics, or a combination thereof, to enhance topographic orientation detection accuracy.

In other embodiments, multi-angle illumination, capturing images from plurality of cameras, capturing shifted image using splitting optics, or a combination thereof, to enhance detection of other parameters, such as defect or feature size, orientation, and defect height and depth.

xii) Feature and Defect Size, Orientation, and Density of Defect Extraction

Spatial frequency analysis shown in FIGS. 29A and 29B reveal various aspects of features, defects and surface finish. The processed defect image is further analyzed by spatial frequency analysis, such as using spatial transformation, to produce a spatial frequency map 2904A and 2904B. In some embodiments, spatial frequency analysis of the processed defect/feature image 2902A and 2902B is analyzed by Fourier transformation (FT), digital spatial transformation, Fast Fourier transformation, or a combination thereof. The transformed image reveals defect orientation and distribution, namely it reveals if the feature is linear as shown in 2902A, elliptical as shown in 2902B, circularly symmetric or asymmetric, and to determine orientation of preferred feature or defect. In some embodiments, defect orientation and distribution detection are achieved digitally such as by line detection in the spatial frequency map, statistical analysis and curve fitting. The spatial frequency map indicates feature or defect orientation and distribution, feature or defect size, and size distribution, or a combination thereof.

An example of defect type and orientation measurement on structure or object is shown for two different types of defects or features FIGS. 29A and 29B, and the resulting spatial frequency map of a linear (FIG. 29A) and circular or elliptical (FIG. 29B) feature. It should be known to those skilled in the art that when the input image 2902A or 2902B contain multiple types of features or defects, such as linear or circular, the spatial frequency map will also contain a combination of linear and circular or circularly symmetric outputs. However, the advantage of using spatial frequency analysis is that each type of defect can be filtered out using a spatial frequency filter, followed by inverse spatial frequency transformation, such as inverse Fourier transform to reveal only one type of feature or defect. For example, if an input image contains both linear and circular features or defects, an FT is performed, and a spatial filter is used that only passes a linear feature of a specific direction, an inverse FT image will then reveal only the linear feature in that particular direction. Similarly, this operation can be repeated in parallel by using different types of spatial filters to distinguish between different types of defects and features. Therefore, spatial frequency analysis enables rapid distinction and classification of various types of defects and features, and their orientation.

Furthermore, surface finish is also captured by spatial frequency analysis depicted in FIGS. 29A and 29B, by analyzing the distribution pattern of a specific type of defect. Surfaces with rough finish produce noise-like background in the spatial frequency map 2904A, 2904B. For example, a smooth surface will have a much narrower spatial frequency signature, closer to the origin, compared to a rough surface, which has a broader response and wider pattern in the spatial frequency domain. For example, a rough surface with microscopic features of nearly circular shaped variations may produce a circular or a ring-like feature in the spatial frequency map 2904A, 2904B. Surface variations with surface roughness of fine features produce circular or ring-like patterns of larger diameter than coarse features in the spatial frequency domain. Therefore, the spatial frequency maps reveal surface roughness as well as enable measurement of average size of the microscopic features of the surface finish.

Additionally, instead of a narrow-ring-like pattern, if the pattern is broadly distributed, namely ranging from small to large spatial frequencies, this indicates surface roughness with wide range of microscopic feature sizes.

Defect orientation determination is achieved by analyzing the data that reveals the defect structure, as shown in FIG. 29A and FIG. 29B. The data is pre-processed using an algorithm to enable accurate spatial frequency analysis, which is then post processed to reveal a defect and other features such as density and orientation. Further processing of this data and using calibration and thresholding algorithms, defects, or other feature orientations are revealed and are displayed on a polar plot as shown in FIGS. 29A and 29B. In some instances, each feature may require a different inspection modality. Extracted data from each modality reveals different features, such as defect direction, and preferential orientation.

Furthermore, spatial frequency analysis also reveals defect density. Namely, the amplitude of the spatial frequency map indicates both the presence of a particular defect or feature of a given size or orientation, but also the distribution of that defect. Large distribution of a particular defect or feature in the input image plane results in high amplitude in the spatial frequency domain.

Furthermore, average defect size is also extracted by analyzing the spatial frequency map 2904A and 2904B. In addition to spatial frequency analysis, both the input image 2901A and 2901B and the spatial frequency map 2904A and 2904B can be further analyzed using various image processing techniques, such as using morphological image processing algorithms to extract further feature of the defect.

It should be known to those skilled in the art that the dimensions of the image plane 2901A and 2901B and spatial frequency map 2904A and 2904B shown in FIGS. 29A and 29B are inversely proportional, and that measurements in spatial frequency domain reveal size of features, defects and microscopic size of surface finish in the image plane, which is determined by various Fourier transform parameters such as sampling frequency and window size.

xiii) Detection and Classification of Different Surfaces

Various types of defects and features can be classification using various methods and apparatus described herein, such distinctions between different types of defects base on size, height or depth, color, and surface finish. In some instances, when multiple layers are present, height or depth, color and surface finish may be used to determine which layer that a particular feature or defect is in.

In some embodiments, a distinction can be made between a known feature and a defect based on various characteristics such as a) shape, such as linear or circular, as shown in FIG. 28A, b) Size or width, such as thick or thin, such as a wide gap or a thin crack as shown in FIG. 28B, c) spectral characteristics, such as color of the defect or the feature, d) surface characteristics, e) depth or height of defect and feature f) and comparing detected signature to known features on the structure or object under test.

### Various Embodiments and Various Applications of the Sensor

In some embodiments, a multi-wavelength and polarization measurements are combined.

In other embodiments a camera with multi-wavelength channel outputs is used to produce multi-color or multi-wavelength images.

In other embodiments, a camera that is responsive to ultraviolet (UV) is used for detection.

In other embodiments, a camera is used that has a wide spectral response covering UV, visible and IR wavelengths.

In other embodiments, a camera with multi-wavelength such as red, green, blue, and infrared (IR) channel outputs is used to produce multi-spectral images.

In other embodiments, a monochrome light, such as a halogen lamp with a filter, light emitting diodes (LED), lasers, or a laser diode (LD) is used as a light source.

In other embodiments, a multi-wavelength variable or tunable filter is used and combined with a broad spectral light source to produce multiple wavelength light source.

In other embodiments, an input polarizer is used for controlling incident light polarization.

In other embodiments an input polarizer followed by a wave-plate is used for controlling incident light polarization.

In other embodiments, a polarizer is used in front of the camera.

In other embodiments, a combination of input polarizer and polarizer in front of the camera are utilized.

In other embodiments, a combination of input polarizer and a wave-plate, and polarizer in front of the camera are utilized.

In other embodiments, a polarization beam splitter is used in front of the camera.

In other embodiments, an array of sources is used for illumination.

In alternative embodiments, sensor arrangements described herein are used for structure body, surface, and surface coating inspection.

In other embodiments, light sources include light emitting diodes, lasers, laser diodes, arc lamps, halogen lamps, flash lamps, fluorescent lamps, thermal sources, fiber optic sources, super luminescent light sources, or any other light source that produces, UV, visible, IR, with monochromatic (single wavelength) or polychromatic (multi-wavelength) spectral output.

In alternative embodiments, sensor arrangements described herein are used with various means of localizing the sensor head that include a wireless system, ultrasonic distance measurement and localization, and optical distance measurement.

In alternative embodiments, sensor arrangements described herein are used with various means of localizing the sensor head that include angular detection, accelerometer-based distance and movement measurement, gyroscope-based angular measurements.

In alternative embodiments, sensor arrangements described herein are used with various means of localizing the sensor head that include time-of-flight signal measurement, such as from an ultrasonic, wireless or optical sensor, pulsing, frequency shift, phase shift and Doppler effect for sensor localization.

In alternative embodiments, sensor arrangements described herein are used with various means of localizing the sensor head that include triangulation and trilateration.

In alternative embodiments, sensor arrangements described herein are used for inspection of manufactured structure parts.

In alternative embodiments, sensor arrangements described herein are used for inspection for quality assurance.

In alternative embodiments, sensor arrangements described herein are used for post fabrication inspection.

In alternative embodiments, sensor arrangements described herein are used for inspection of mobile or stationary surfaces.

In alternative embodiments, sensor arrangements described herein are used for detecting and characterizing voids, inclusions, line breakage, sag, bulging, delamination, and variations in surface finish, missing lines and fibers, and variations in fiber spacing, such as in a fiber glass body.

In alternative embodiments, sensor arrangements described herein are used for inspecting plastic and metal parts.

In alternative embodiments, sensor arrangements described herein are used for inspecting nylon and fiberglass parts.

In alternative embodiments, sensor arrangements described are used for organic, inorganic, or metallic part inspection.

In alternative embodiments, sensor arrangements described herein use single polarization state, multiple polarization states, or differential polarization, namely calculating difference in polarization states, or a combination thereof.

In alternative embodiments, sensor arrangements described herein use single polarization angle, multiple polarization angles, and use single or multiple incident angles of the polarized light, or a combination thereof.

In alternative embodiments, sensor arrangements described herein use linear, circular, or elliptical polarization states, or a combination thereof.

In alternative embodiments, sensor arrangements described herein use stationary or rotating polarizers, stationary or rotating wave plates, polarization controlling apparatus, liquid crystal-based polarization controlling apparatus, electro-optic modulator and phase shifter devices to control polarization and phase states, polymeric based electro-optic modulators and phase shifters, lithium niobate and silicon based electro-optic modulators and phase shifters, thermal polymer based electro-optic modulator and phase shifter, holographic phase shifter, or any polarization controller or phase shifters, or a combination thereof.

In alternative embodiments, sensor arrangements described herein use multiple polarization angle measurements using rotating polarizers.

In alternative embodiments, sensor arrangements described herein use multiple polarization angle measurements using multiple polarizers or polarization beam splitters.

In alternative embodiments, sensor arrangements described herein use multiple polarization angle measurements using pixelated polarizers in front of the camera.

In some embodiments, the structure being inspected may be a mobile structure, a stationary structure, or a combination thereof.

In some embodiments, the inspection is performed only in a small portion of the object under test. Yet in other embodiments, inspection is performed on an entire or a large structure. When a large structure is tested, an entire map is generated from multiple measurement using the spatial information used is achieved using the positioning system depicted in FIG. 1A.

In some embodiments, sensor data is transmitted to the central system using a wireless transmission. In other embodiments, sensor data is transmitted to the central system using a wired connection, or an optical connection or an ultrasonic connection, or a combination thereof.

In some embodiments, positioning information is generated using wireless transmitters and receivers. In other embodiments, positioning information is generated using ultrasonic transmitters and receivers. Yet in other embodiments, positioning information is generated using laser-based and optical-based transmitters and receivers. Yet in other embodiments, positioning information is generated using a combination of optical image generated by the sensor head and combined with using optical or digital image correlation with a known image of the structure under test.

In some embodiments, the sensor head depicted in FIGS. 1A, 1B FIGS. 12, 13, 14, and 15 depicted in other FIGUREs and described herein can be a hand-held, portable unit, a unit mounted on a mobile apparatus, attached to a manual, automated, or a semi-automated scanning structure, or a fixed holder.

In other embodiments, the sensor head depicted in FIGS. 1A, 1B, FIGS. 12, 13, 14, and 15 depicted in other FIGUREs and described herein can be a single unit or an array of sensor units positioned in a fixed location, and the structure is movable with respect to the sensor head or sensor unit array to achieve full-structure scan.

In other embodiments, the sensor head depicted in FIGS. 1A, 1B, FIGS. 12, 13, 14, and 15 depicted in other FIGUREs and described herein can be a single unit, or a sensor array mounted on a movable arm, a robotic arm, or an autonomous vehicle to scan the structure.

In various embodiments described herein, the attachment 1537 utilizes long-working distance optics such as a telecentric lens.

In some embodiments, light sources include same wavelength light source. In other embodiments only one set of wavelength light sources is used. Yet in other embodiments, light sources of two or more different wavelengths are utilized. Yet in other embodiments, each light source is of different wavelength, either controlled by various switching mechanism to select different elements of the light source or using an optical filter in combination with a broad band light source to select a specific illumination wavelength or wavelength range.

To enable a high degree of detection, to keep a sharp focus of the detected images, or to keep a constant area of detection window, in various embodiments described herein, both the illumination and the detection of the sensor can be adjusted in real time. In other embodiments, zoom optics using fixed focal length, or manually or electronically adjustable focal length are used as long working distance optics. In other embodiments, to maintain a sharp focus, a telecentric lens is used to maintain sharp focus. In other embodiments, a multiple component optical configuration can be used that includes a combination of positive and negative lenses and spatial filters that enables long depth of focus. In some embodiments, the illumination angle can be controlled using adjustable focal length optics to limit the illumination to the area of detection, such as using zoom optics and electronically controlled focal length optics.

The data produced from the sensor head depicted in various embodiments may be digitally processed or pre-processed for noise reduction, such as digital low-pass filtering, and using various processing prior to producing the detected modalities. In some embodiments, pre-processing of data include low-pass and high-pass filtering and a combination thereof, digital filtering, image or pixel thresholding, morphological image processing such as dilation and erosion operations, lock-in detection such as synchronizing the detection with modulation of the light source to remove noise, lock-in detection such as synchronizing the detection with scattering media modulation to remove noise, adding or subtracting various image frames, digital averaging of multiple frame images, and removing background variations by subtracting a reference image from the detected image. In other embodiments, pre-processing includes synchronizing image with multi-wavelength or multi-spectral source modulation, and separating various spectral channels, such as red, green, blue and infrared, from the camera output, or a combination thereof.

In some embodiments similar to shown in FIGS. 17, 18, 19, 20 and 21, various pattern projection techniques may be combined with sensor configurations to determine height or depth of a feature or defect, as depicted in FIGS. 34A and 34B. Namely a projected pattern may deviate from its original shape to a shape due to topographic variations of the inspected surface. Furthermore, the direction of pattern deviation indicates the topographic direction of a feature or defect, if it is a protrusion or an indentation. For example, a tilt in the surface produced a tilt in the projected line pattern. A dent in the surface will produce a local shift of the line pattern where the dent is present.

In various embodiments described herein, the pattern projection depicted in FIGS. 17, 18, 19, 20 and 21 and protrusion and indentation detection depicted in FIGS. 34A and 34B can be combined with other depth and height measurements to increase depth, height and topographic orientation measurement accuracy.

Throughout this disclosure, structure, specimen, and object are used interchangeably.

Throughout this disclosure word intensity, amplitude or pixel value, or dark or bright pixel are used interchangeably to indicate brightness of the camera or detector array pixel.

While it has not been mentioned, one familiar with the art would realize that the device is not limited by the materials used to create each apparatus that comprises the invention. Any other material type can comprise some or all of the elements in constructing a detachable document holder system in various embodiments of the present invention.

Although the present invention has been illustrated and described herein with reference to preferred embodiments and specific examples, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A multi-modal inspection apparatus for detecting surface and structural defects in a structure, comprising:
a structure having a structural surface feature having surface and structural defects;
at least one position registration device;
a sensor capable of moving along the structural surface for detecting the structural surface feature such that the sensor is located adjacent to the at least one position registration device,
wherein the sensor includes a plurality of light sources for emitting light on the structural surface in order to illuminate the structural surface feature, wherein each of plurality of light sources is configured to emit a different wavelength of light, and at least one image capturing device for detecting a shadow of the structural surface feature generated by the plurality of light sources and associated with the structural surface feature; and
a processor operatively connected to the sensor and the at least one position registration device for processing information from the sensor and the at least one position registration device and providing a map of any surface and structural defects in the structural surface.

2. The multi-modal inspection apparatus, as in claim 1, wherein the multi-modal inspection apparatus is further comprised of:
a pattern generator for generating a pattern on the structural surface, wherein the at least one image capturing device is configured to detect a shift in the pattern.

3. The multi-modal inspection apparatus, as in claim 1, wherein the multi-modal inspection apparatus is further comprised of:
at least one switch operatively connected to the plurality of plurality of light sources, wherein the at least one switch is configured to turn on and turn off each of the plurality of light sources.

4. The multi-modal inspection apparatus, as in claim 1, wherein the multi-modal inspection apparatus is further comprised of:
focusing optics located adjacent to the plurality of light sources, wherein the focusing optics are configured to form an image of the structural surface feature onto the at least one image capturing device.

5. The multi-modal inspection apparatus, as in claim 4, wherein the processor is further comprised of:
an image processing apparatus for detecting a height, a depth, a size, and a topographical orientation of the surface and structural defects for a surface scan area on the structural surface that is incident to the sensor,
wherein the image processing apparatus performs the following;
obtain the image from the structural surface area scan,
pre-processing the image by performing a spatial frequency transformation on the image to a pattern in a spatial frequency domain, and
determine a height, a depth, a size, and a topographical orientation of the surface and structural defects in the structural surface associated with the image using the pattern in the spatial frequency domain.

6. The multi-modal inspection apparatus, as in claim 1, wherein the multi-modal inspection apparatus is further comprised of:
a polarizer located adjacent to the at least one image capturing device.

7. A multi-modal inspection apparatus for detecting surface and structural defects in a structure, comprising:
a structure having a structural surface feature having surface and structural defects;
at least one position registration device;
a sensor capable of moving along the structural surface for detecting the structural surface feature such that the sensor is located adjacent to the at least one position registration device,
wherein the sensor includes a plurality of light sources for emitting light on the structural surface in order to illuminate the structural surface feature, wherein each of plurality of light sources is configured to emit a different wavelength of light, and a plurality of image capturing devices for detecting an image shift of the structural surface feature generated by the plurality of light sources and associated with the structural surface feature; and
a processor operatively connected to the sensor and the at least one position registration device for processing information from the sensor and the at least one position registration device and providing a map of any surface and structural defects in the structural surface.

8. The multi-modal inspection apparatus, as in claim 7, wherein the multi-modal inspection apparatus is further comprised of:
a pattern generator for generating a pattern on the structural surface, wherein the plurality of image capturing devices are configured to detect a shift in the pattern.

9. The multi-modal inspection apparatus, as in claim 7, wherein the multi-modal inspection apparatus is further comprised of:
at least one switch operatively connected to the plurality of plurality of light sources, wherein the at least one switch is configured to turn on and turn off each of the plurality of light sources.

10. The multi-modal inspection apparatus, as in claim 7, wherein the multi-modal inspection apparatus is further comprised of:
focusing optics located adjacent to the plurality of light sources, wherein the focusing optics are configured to form an image of the structural surface feature onto the plurality of image capturing devices.

11. The multi-modal inspection apparatus, as in claim 10, wherein the focusing optics are further comprised of:
a beam splitter, wherein the beam splitter is configured to generate a double image of the image of the structural surface feature for subsequent capturing of the double image by the plurality of image capturing devices.

12. The multi-modal inspection apparatus, as in claim 10, wherein the processor is further comprised of:
an image processing apparatus for detecting a height, a depth, a size, and a topographical orientation of the surface and structural defects for a surface scan area on the structural surface that is incident to the sensor,
wherein the image processing apparatus performs the following;
obtain the image from the structural surface area scan,
pre-processing the image by performing a spatial frequency transformation on the image to a pattern in a spatial frequency domain, and
determine a height, a depth, a size, and a topographical orientation of the surface and structural defects in the structural surface associated with the image using the pattern in the spatial frequency domain.

13. The multi-modal inspection apparatus, as in claim 7, wherein the multi-modal inspection apparatus is further comprised of:
a polarizer located adjacent to the plurality of image capturing devices.

14. A multi-modal inspection apparatus for detecting surface and structural defects in a structure, comprising:
a structure having a structural surface feature having surface and structural defects;
at least one position registration device;
a sensor capable of moving along the structural surface for detecting the structural surface feature such that the sensor is located adjacent to the at least one position registration device,
wherein the sensor includes a plurality of light sources for emitting light on the structural surface in order to illuminate the structural surface feature, wherein each of plurality of light sources is configured to emit a different wavelength of light, and at least one image capturing device for detecting a shadow and an image shift of the structural surface feature generated by the plurality of light sources and associated with the structural surface feature; and
a processor operatively connected to the sensor and the at least one position registration device for processing information from the sensor and the at least one position registration device and providing a map of any surface and structural defects in the structural surface.

15. The multi-modal inspection apparatus, as in claim 14, wherein the multi-modal inspection apparatus is further comprised of:
a pattern generator for generating a pattern on the structural surface, wherein the at least one image capturing device is configured to detect a shift in the pattern.

16. The multi-modal inspection apparatus, as in claim 14, wherein the multi-modal inspection apparatus is further comprised of:
at least one switch operatively connected to the plurality of plurality of light sources, wherein the at least one switch is configured to turn on and turn off each of the plurality of light sources.

17. The multi-modal inspection apparatus, as in claim 14, wherein the multi-modal inspection apparatus is further comprised of:
focusing optics located adjacent to the plurality of light sources, wherein the focusing optics are configured to form an image of the structural surface feature onto the at least one image capturing device.

18. The multi-modal inspection apparatus, as in claim 17, wherein the focusing optics are further comprised of:
a beam splitter, wherein the beam splitter is configured to generate a double image of the image of the structural surface feature for subsequent capturing of the double image by the image capturing device.

19. The multi-modal inspection apparatus, as in claim 17, wherein the processor is further comprised of:
an image processing apparatus for detecting a height, a depth, a size, and a topographical orientation of the surface and structural defects for a surface scan area on the structural surface that is incident to the sensor,
wherein the image processing apparatus performs the following;
obtain the image from the structural surface area scan,
pre-processing the image by performing a spatial frequency transformation on the image to a pattern in a spatial frequency domain, and
determine a height, a depth, a size, and a topographical orientation of the surface and structural defects in the structural surface associated with the image using the pattern in the spatial frequency domain.

20. The multi-modal inspection apparatus, as in claim 14, wherein the multi-modal inspection apparatus is further comprised of:
a polarizer located adjacent to the at least one image capturing device.
